(19) United States
(12) Patent Application Publication
(10) Pub. No.: US 2026/0268272 A1
(43) Pub. Date: Sep. 10, 2026

(54) SUPPLY CHAIN VISUALIZATION AND CONTROL

(71) Applicant: Sys-Tech Solutions. Inc., Princeton, NJ (US)

(72) Inventor: Stephen Robert Lisa, Columbus, NJ (US)

(21) Appl. No.: 18/873,632

(22) PCT Filed: Jun. 23, 2023
(86) PCT No.: PCT/US2023/026144

§ 371 Date: Dec. 10, 2024

Related U.S. Application Data
(60) Provisional application No. 63/355,538, filed on Jun. 24, 2022.

(51) Int. Cl. G06Q 10/087

(52) U.S. Cl. CPC G06Q 10/08744

(57) ABSTRACT

The present systems and techniques enable supply chain visualization. Data regarding items can be obtained as the items move through a supply chain, wherein the data includes event data that identifies specific ones of the items at specific locations in the supply chain at specific times. The data can be analyzed to produce information while at least a portion of the items move through the supply chain. A visualization of the information can be provided, and the visualization can be usable to identify one or more changes to make in at least one portion of the supply chain to improve the at least one portion of the supply chain.

### CROSS-REFERENCE TO RELATED APPLICATIONS

This patent application claims priority to and the benefit of U.S. Provisional Patent Application No. 63/355,538, filed on Jun. 24, 2022, which is incorporated herein by reference in its entirety.

### BACKGROUND

Items travel through various points in a supply chain between a producer of the product and a consumer. For example, an item might be created in a factory at a first location, then shipped to a warehouse at a second location. The product might then be transported to a retail store at a third location, and eventually sold to a consumer.

### SUMMARY

This specification describes technologies relating to supply chain visualization using data for items as the items move through a supply chain. The visualization can be usable to identify changes to make in the supply chain to improve the supply chain.

In general, one or more aspects of the subject matter described in this specification can be embodied in one or more methods (and also one or more non-transitory computer-readable mediums tangibly encoding a computer program operable to cause data processing apparatus to perform operations) including: obtaining data regarding items as the items move through a supply chain, wherein the data includes event data that identifies specific ones of the items at specific locations in the supply chain at specific times; analyzing the data to produce information while at least a portion of the items move through the supply chain; and providing a visualization of the information usable to identify one or more changes to make in at least one portion of the supply chain to improve the at least one portion of the supply chain.

One or more aspects of the subject matter described in this specification can also be embodied in one or more systems including: a data processing apparatus including at least one hardware processor; and a non-transitory computer-readable medium encoding instructions configured to cause the data processing apparatus to perform operations including: obtaining data regarding items as the items move through a supply chain, wherein the data includes event data that identifies specific ones of the items at specific locations in the supply chain at specific times; analyzing the data to produce information while at least a portion of the items move through the supply chain; and providing a visualization of the information usable to identify one or more changes to make in at least one portion of the supply chain to improve the at least one portion of the supply chain.

Particular embodiments of the subject matter described in this specification can be implemented to realize one or more of the following advantages. The systems and techniques can provide supply chain visibility, giving a full range of actionable knowledge in real time using event data collected as products move through a supply chain. The systems and techniques can assess supply chain performance using data generated by end-to-end serialization. In some implementations, the systems and techniques can utilize both real-time and historical data, provide information and alerts, pre-packaged reports, dashboards, strategic identification of trends and potential threats, and test environments accessible to multiple users of the supply chain. The visualization of the information can be used to identify changes to make in the supply chain to improve the performance of the supply chain.

In some implementations, the systems and techniques can provide insight and granularity of the supply chain to save time in determining root causes for production issues, sending notifications to users when production events that need to be addressed or resolved are happening. In some implementations, the systems and techniques can provide visualization that can be used to increase throughput on production lines, to make faster and more accurate corrections, and to minimize downtime or loss. In some implementations, the systems and techniques can perform anti-counterfeiting and product authentication. For example, the system can prevent product diversion at distributors, can confirm product authenticity at retailers, and can enable engagement and foster brand loyalty at the customer end. In some implementations, the systems and techniques can use end-to-end item trace data to generate information that helps manufacturers to track and trace products through the supply chain.

In some implementations, the systems and techniques can take data collected for serialization regulatory purposes and can determine the performance of the supply chain using the regulatory collected data. In some implementations, the systems and techniques can use existing data collectors, cameras, scanners, and sensors in a supply chain, and do not require special data collectors or special sensors to be added. In some implementations, the systems and techniques can perform full stack (L1-L4) serialization and can be deployed rapidly on lines, sites, or enterprises in a region to meet the regulations in the region. The systems and techniques can be configured to fit any unique needs of supply chain partners, and is cost-effective, comprehensive and packaging equipment agnostic. The systems and techniques can deliver seamless, standardized communications between supply chain partners, including manufacturers, packagers, distributors, retailers, wholesalers, and customers. Additional advantages can include advanced visualization and customizable dashboards that cater to different user roles, real-time global monitoring and visualization capabilities, granting users comprehensive oversight regardless of geographic location, incorporation of data-driven insights, encouraging continuous improvement and informed, proactive responses to potential disruptions, integrated anti-counterfeiting measures, and real-time optimization of line performance.

The details of one or more embodiments of the subject matter described in this specification are set forth in the accompanying drawings and the description below. Other features, aspects, and advantages of the invention will become apparent from the description, the drawings, and the claims.

### BRIEF DESCRIPTION OF THE DRAWINGS

FIG. 1 shows an example of a system usable to provide a visualization of information of a supply chain.

FIG. 2 shows an example of a production line.

FIG. 3 is a flowchart showing an example of a process to provide a visualization of information of a supply chain.

FIG. 4 shows an example of levels of serialization.

FIG. 5 shows examples of information of a supply chain.

FIGS. 6A-6B show examples of dashboards for displaying decommission events.

FIGS. 7A-7B show examples of dashboards for packaging line utilization and performance.

FIGS. 8A-8C show examples of dashboards for serial number pool status and serial number allocations.

FIGS. 9A-9B show examples of dashboards for packaging lot/batch details.

FIGS. 10A-10B shows examples of dashboards.

FIG. 11 shows an example of a single point of view system/platform.

### DETAILED DESCRIPTION

Sometimes, improvements to one or more portions of a supply chain are desired. For example, plant managers may want to increase throughput on production lines. Production efficiency can be increased by tackling high downtime, low performance, and poor-quality information. Improvements to existing infrastructure or processes can be a preferred option when the changes to make are known. Many companies do not have the information they need to determine the improvements to implement, let alone track production losses effectively. A key reason is the cost and difficulty in capturing the data in a supply chain and actionable insight into the data.

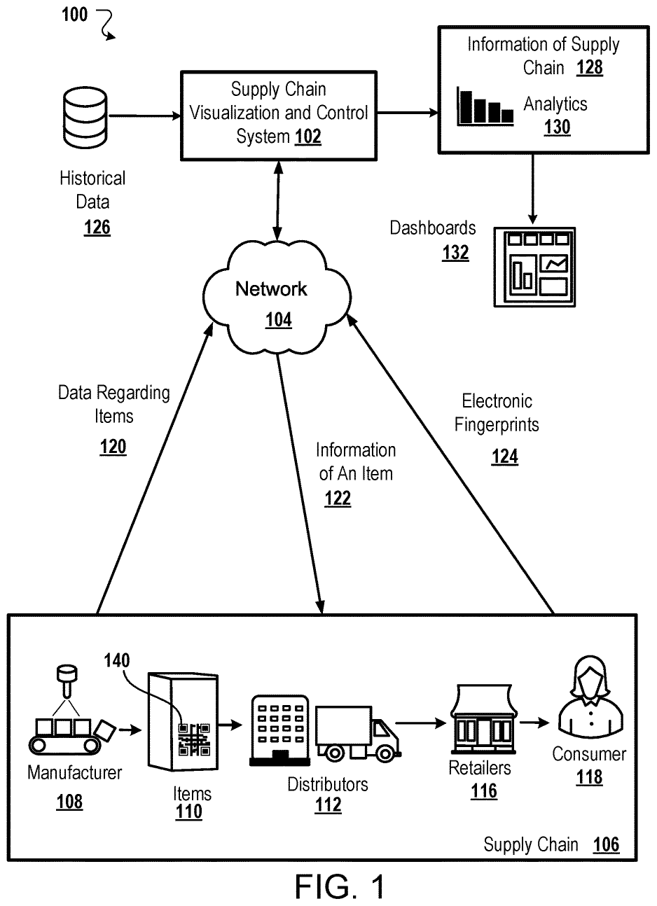

FIG. 1 shows an example of a system usable to provide a visualization of information of a supply chain. FIG. 1 shows an environment 100 that includes a supply chain visualization and control system 102, a network 104, and a supply chain 106.

A supply chain is a sequence of processes involved in the production and distribution of an item, e.g., a commodity or a product. A supply chain can include multiple locations that items travel through. For example, the supply chain 106 includes a manufacturer 108, a distributor 112, a retailer 116, and a consumer 118. Items 110, e.g., products, manufactured and packaged by the manufacturer 108 travel through the supply chain 106. During manufacturing, the items can move from different sites of the manufacturer 108. After manufacturing, the items 110 can be shipped by one or more distributors 112 to one or more retailers 116. The retailers 116 can sell the items 110 to one or more consumers 118. In some implementations, a distributor can send the items to a wholesaler, and a wholesaler can send the items to a retailer.

The supply chain 106 can generate data 120 regarding items 110 as the items 110 move through the supply chain 106. Different events happen at each location in the supply chain. The data 120 can include event data that identifies specific ones of the items at specific locations in the supply chain 106 at specific times. For example, possible events that can potentially happen at each of these locations (e.g., manufacturer, packager, distributor, wholesaler, and retailer) in the supply chain can include commissioning, decommissioning, packing, shipping, quality assurance (QA) sampling, receiving, unpacking, destroying, and dispensing.

In some implementations, the data 120 can include lot-based events, machine-based events, or a combination of both. The lot-based events can include starting a lot, suspending a lot, resuming a lot, ending a lot. Machine (e.g., packaging site management server/computer) based events can include machine available, user logged in, maintenance mode, machine in lot (active), offline/powered down. Some events can be sent in batches (e.g., lot based) and some single events (e.g., health and heartbeat messages, alerts, and alarms) can be sent as they arise. Events can include time interval data (e.g., health and heartbeat messages).

In some implementations, the data 120 regarding the items can include counts for commissioned and decommissioned items for a snapshot in time and/or associated with a segment in the supply chain. A commission event describes an item coming into existence in the supply chain. For example, a commission event happens when an item is manufactured, an item passes an inspection, an item is determined to be good, or when a parcel is received at a wholesaler. A decommission event describes an item being removed from the supply chain, when an item fails an inspection, or an item is rejected. For example, a decommission event happens when a defective item is discarded, or when a product is purchased by a customer at a retail store.

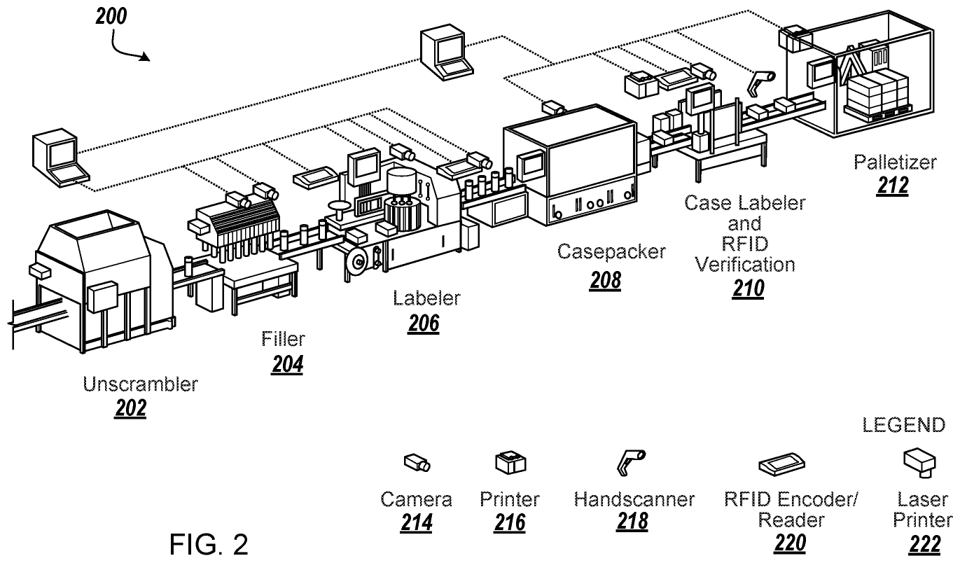

In some implementations, the counts for commissioned and decommissioned items can be obtained from inspection data collected on a production line by sensors installed on the production line. For example, events that happen at a manufacturer 108 can include events that happen on a production line. FIG. 2 shows an example of a production line 200. The production line can include various devices for manufacturing and/or packaging the items. For example, the production line 200 includes a unscrambler 202, a filler 204, a labeler 206, a casepacker 208, a case labeler and radio-frequency identification (RFID) verification machine 210, and a palletizer 212. Many other variations of a production line 200 are also possible. Further, various sensors can be installed on the production line 200, such as one or more cameras 214, one or more printers 216 (e.g., one or more laser printers 222), one or more hand scanners 218, one or more RFID readers 220, etc. Counts for commissioned and decommissioned items can be obtained from inspection data collected on the production line 200 by a scanner or a camera installed on the production line 200.

Referring back to FIG. 1, in some implementations, the data 120 at each location can be generated by a server at the location. For example, data associated with packaging can be generated by a packaging lot/site management server. The packaging site management server can adjust the data and can send the data, e.g., as a list of events, to the system 102. Events for the packaging site management server can trigger the server to send further information to the system 102.

Data associated with packaging lots can include lot identification (e.g., lot number, expire date, product, manufacturer, site, line), events (e.g., start, suspend, resume, end; times; running, suspended, elapsed), container (packaging level, name), counts (commissioned, decommissioned, packed, not-packed, items per interval), decommission details (container level, reasons, locations), lot control variables, serial number allocation (allocated, used, returned), etc. In some examples, data associated with packaging sites can include geo location, manufactures, products, lines, and serial number pool status.

In some implementations, data regarding items 120 can be collected by an Item Process Stream (IPS). The IPS can be implemented using one or more details from U.S. Pat. No. 8,190,279, which is hereby incorporated by reference in its entirety. In some implementations, the data 120 can include data and timestamps of each of the items inspected on a packaging line. Every time an item is inspected as being a pass or a failure (e.g., commissioned/decommissioned), this gets a timestamp. Data can include packaging lot, profiled one lot at a time. Data can include packaging level, whether it's a carton case, bundle, or pallet. Data can include information related to grouping the items together and average items per minute. Data can include how many items are moving on a packaging line at any given time during production. In some implementations, data can be stored in a database.

The supply chain visualization and control system 102 can be a real-time supply chain monitoring and control system that monitors and controls a supply chain. The supply chain visualization and control system 102 obtains data 120 regarding items through a network 104. The network 104 can be a private network, a public network, a virtual private network, a wired or wireless network, etc. In some implementations, the network 104 can be a global communication network and the system 102 can obtain the data 120 regarding items via the global communication network as the items move through a wide range of regions and areas.

The system 102 processes the data 120 regarding the items and produces information 128 of the supply chain 106, while the items 110 move through the supply chain 106. The system 102 can process the data 120 using data analytics, e.g., machine learning and artificial intelligence. The information 128 can include one or more of analytics and/or metrics 130 of at least one portion of the supply chain. For example, the information 128 can include decommissioning information, serial number pool information, packaging line performance information, and packaging lot information. In some examples, the information 128 can include lot decommission profile, packaging lot alarms, packaging lot events, power fail, and audit logs. In some implementations, the system 102 can include predictive analytics capability. Leveraging the power of machine learning algorithms and artificial intelligence, the system can process not just historical data but predict future trends based on this data. It can forecast potential disruptions in the supply chain, allowing for preventative measures to be taken to maintain smooth operations. These predictions can be part of the information 128 produced by the system.

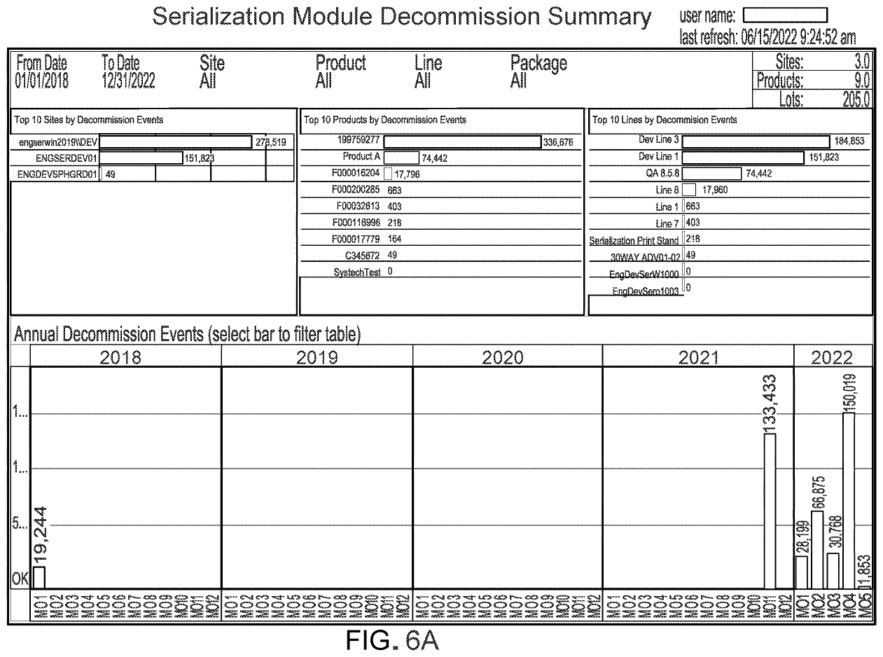

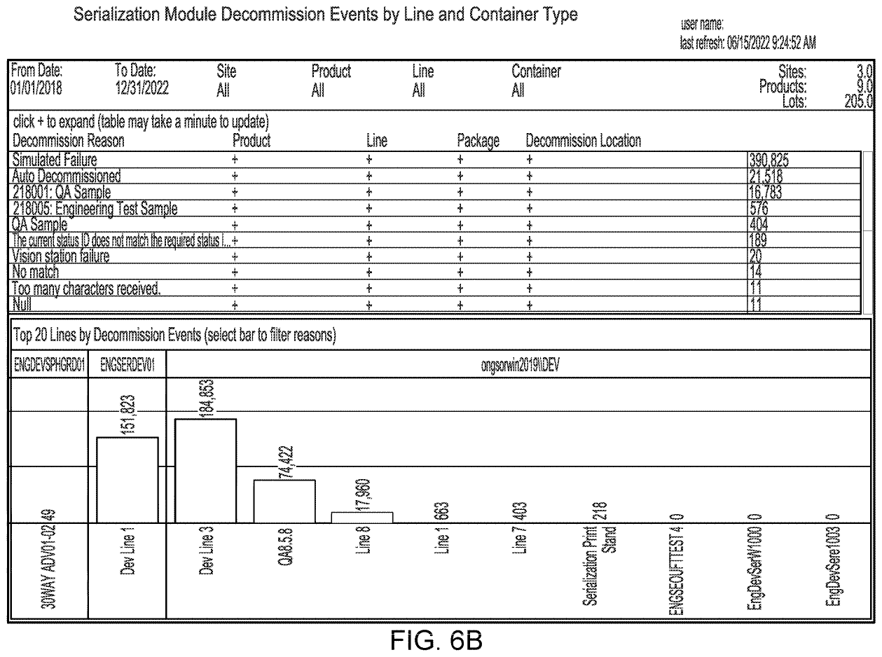

The system 102 can provide a visualization of the information. In some implementations, the system 102 can generate at least one dashboard 132 that organizes and displays the information 128 of the supply chain. For example, dashboards 132 can provide a view of packaging site hierarchy, serialization and lot data, and line details in a single source (e.g., a data visualization system). In some implementations, the system 102 can manage supply chain data, including serialization of products using standard codes, nonstandard codes, or a combination of both, for a supply chain operation. The dashboards 132 can include information related to production (by site, product, manufacturer), decommission details (by site, product, manufacturer), lot summary (e.g., a line manager lot summary report), serial number allocation by lot, a packaging site management server serial number pool status, packaging line performance commission, decommission, parts per minute across multiple lots, and lot runtime profile performance from start to end. More examples of dashboards are described below in connection with FIGS. 6-10. In some implementations, the visualization of the information can include multiple views, e.g., a production view with work orders, a notification/explorers view, and a node view. In some implementations, the multiple views can be displayed in multiple dashboards.

In some implementations, a key component of the dashboards 132 can be a real-time alerts system. In some implementations, the system 102 can generate alerts that are based on predictive analytics, which can highlight potential disruptions or anomalies in the supply chain. The system 102 can provide a proactive approach to managing the supply chain, alerting relevant stakeholders to potential issues before they become significant problems. In addition to forecasting potential disruptions, the system 102 having the predictive analytics capability can also anticipate future resource requirements. The system 102 with this predictive resource management feature can use trained machine learning models to estimate the demand for raw materials, labor, and capacity at each stage of the supply chain based on historical and real-time data. This proactive approach allows supply chain managers to optimize resource allocation, prevent bottlenecks, and reduce waste, enhancing the overall efficiency and sustainability of the supply chain operations.

A user of the system can use the visualization of the information to identify one or more changes to make in the supply chain to improve the supply chain. For example, high level decommissioning can be identified using counts and can be analyzed using decommissioning reasons, which can depend on a role within a company. Provisioning is obtaining serial numbers from a master source. For example, the quantity of available serial numbers can be visualized, and during serial number provisioning, a user can avoid production of duplicates based on the visualization. A packaging site management server can get a master set and a decommission set that are managed by the system 102. Plant production people can use a dashboard for decommissioning. For example, when a product gets thrown away, the plant production people can analyze why it was decommissioned based on the dashboard. In some implementations, the system 102 can integrate blockchain technology for secure data-sharing across the supply chain.

As another example, information technology (IT) people and serialization management people can use serial number pools and allocation dashboard. Sometimes, it is difficult to know when serial numbers is empty. Although the system may provide email notification to relevant users, the person receiving the email may not respond to it or may be on vacation. The present systems and techniques can make sure that enough serial numbers are available to run production. For example, in China, serial numbers are purchased from the government. A serialization management user or production line manager can notice that a particular production line that has 100 serial number pools is empty but multiple products and packaging levels are configured to begin production. If a user tries to run production on any of those products, they would not be able to start the lot because the serial numbers are empty. The present system and techniques can ensure that anyone can view at any time that serial numbers are low or empty and is able to notify somebody before it impacts production.

The real-time supply chain visualization and control system 102 provides supply chain visibility, giving a full range of actionable knowledge in real time. As the items 110 move through the supply chain 106, event data 120 is generated. The event data 120 includes but is not limited to collecting and storing critical data with timestamps. End to end serialization generates data 120 that can be used for assessing supply chain performance. Therefore, the system 102 can provide practical insight and connectivity from the very start of deployment. In some implementations, the system 102 can process both real-time and historical data and can generate information and alerts, pre-packaged reports and dashboards, strategic identification of trends and potential threats, and test environments accessible to multiple users.

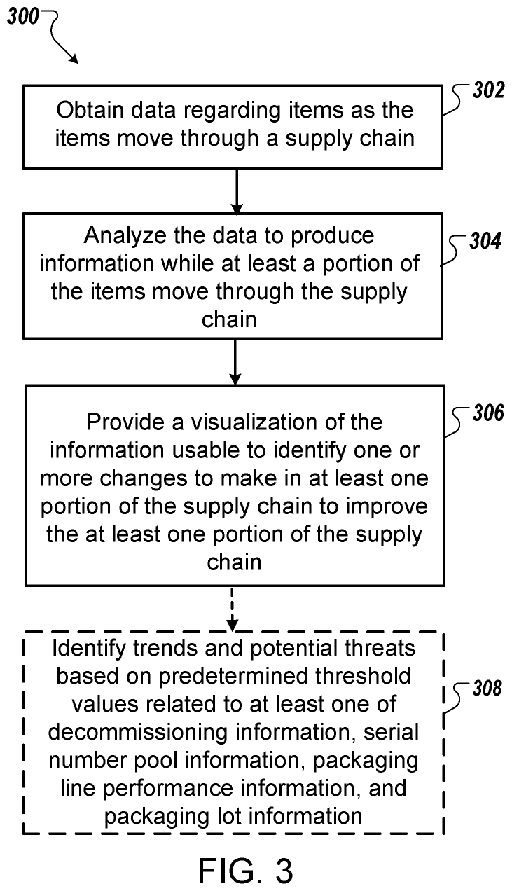

FIG. 3 is a flowchart showing an example of a process 300 to provide a visualization of information of a supply chain. For example, the system 102 of FIG. 1 can perform the process 300. Data regarding items is obtained 302 as the items move through a supply chain. In some implementations, the data can include event data that identifies specific ones of the items at specific locations in the supply chain at specific times. For example, the system 102 can obtain, over the network 104, event data that identifies a box of toys that is unpacked at a distributor 112 at a first time of a specific day and is repackaged and shipped to a retailer at a later time of that day.

In some implementations, the system 102 can process unstructured data, which may originate from various sources, such as feedback comments, emails, machine logs, technician reports, customer inquiries, and internal communications. The system 102 employs advanced Natural Language Processing (NLP) techniques to process this unstructured data, extracting relevant information regarding the supply chain's performance. The extracted information can be subsequently converted into a structured format and incorporated into the overall supply chain data 120. In this way, the system 102 can provide a more holistic and comprehensive view of the supply chain's performance, which includes not only the quantitative data but also qualitative insights derived from unstructured data.

In some implementations, instead of installing separate data collection devices and data historian servers, the system can obtain data of the items collected from existing packaging site servers and packaging line management systems. This can reduce the cost and improve the efficiency of implementing the supply chain visualization and control system 102. Additionally, the system can further optimize the data collection process by incorporating edge computing devices deployed within the packaging site servers and packaging line management systems. These edge computing devices can directly capture and process the data at the source, eliminating the need for separate data collection devices. The captured data can be transmitted securely to the system 102, ensuring real-time access to accurate and up-to-date information regarding the supply chain's performance.

In some implementations, the data regarding items can include counts for commissioned and decommissioned items for a snapshot in time and/or associated with a segment in the supply chain. In some implementations, data regarding items includes counts for commissioned and decommissioned items during packaging and/or from a particular site. In some implementations, the counts can be obtained from inspection data collected on a production line by sensors installed on the production line. For example, referring to FIG. 1 and FIG. 2, the system 102 can obtain counts for commissioned and decommissioned items over a period of time at one or more segments of the production line 200, e.g., at the unscrambler 202, at the filler 204, at the labeler 206, etc. The counts can be obtained from cameras 214 and/or label scanners 218 and 220 installed on the production line 200. Furthermore, the system 102 can implement advanced computer vision algorithms to analyze the collected visual data and precisely identify and count the commissioned and decommissioned items. These computer vision algorithms can leverage deep learning techniques to accurately recognize and track the items as they progress through the production line. By incorporating computer vision capabilities, the system 102 enhances its ability to provide real-time and reliable information regarding the supply chain's performance.

In some implementations, the system can receive serialization data for the items from computers located at production facilities, packaging facilities, distribution facilities, or a combination thereof. The computers can be dedicated computer systems or smartphones. Serialization is a process of tracking and tracing items from the point of manufacture to the point of sale. Utilizing advanced decoding algorithms, these unique identifiers enable efficient, precise location and status tracking of individual products as they progress through the supply chain. It can be a process of assigning a unique identifier to each item, which is used to track and trace the item throughout the supply chain. For example, the manufacturer can attach a mark 140, e.g., a barcode, a quick response (QR) code, or any other suitable symbol, to a package of a product. The system 102 can use the mark 140 to track and trace the items that move in the supply chain 106 by generating serialization data. The serialization data can include a globally unique serial number assigned to the items 110 moving through the supply chain. For example, serialization data for drugs in a global supply chain can help pharmaceutical counterfeiting, achieve simplified compliance to regulations, and protect patients. In some implementations, the serialization data can include data of ingredient, part, component, product, package, seal, or anything associated with a packaging line.

In some implementations, the serialization data can be generated at various levels. Utilizing Internet of Things (IOT) technology, sensor data and metadata from various points in the supply chain can be collected at high-frequency intervals. The timestamped data, collected and stored in the cloud, is subsequently available for real-time analysis and long-term historical analysis, aiding in both immediate decision-making and long-term strategic planning. In some implementations, the serialization data can be generated by a serialization module. In some implementations, the serialization module can be included in the system 102 and the system 102 can perform the serialization and generates the serialization data. In some implementations, the serialization data can be generated by one or more computers at one or more locations in the supply chain. For example, the serialization data for the items 110 can be obtained at manufacturer 108, distributors 112, retailers 116, or a combination thereof. Additionally, the system 102 can employ advanced data aggregation techniques to consolidate the serialization data from various sources, ensuring a unified and comprehensive view of the items' serialization status throughout the supply chain. By integrating data from multiple points, the system 102 provides a more accurate and reliable representation of the supply chain's serialization performance.

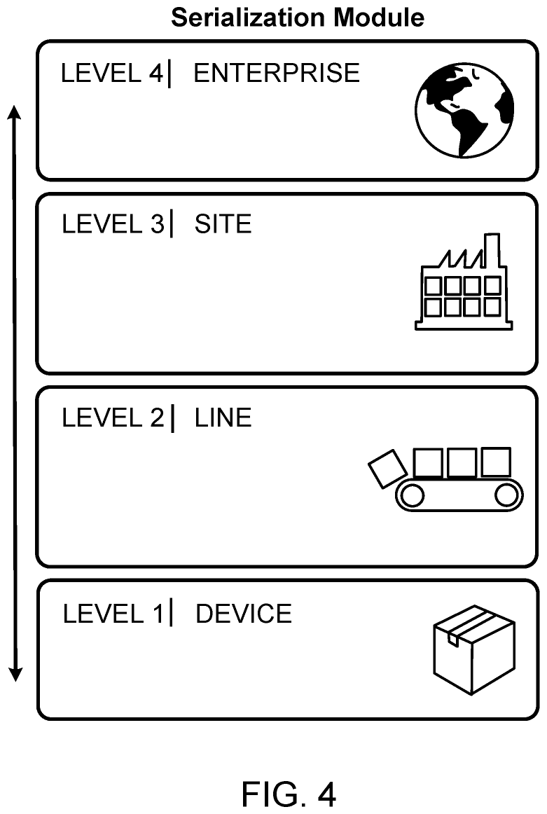

In some implementations, the serialization data of the items can be associated with levels shown in FIG. 4. FIG. 4 shows an example of levels of serialization. In some implementations, the system employs a modular design architecture, enabling tailored functionality for each user group, while maintaining cohesion and seamless communication between all components. Advanced access control and data partitioning techniques are used to ensure that each stakeholder, such as a manufacturer, a packager, a distributor, a retailer, or an end consumer, receives only the pertinent, role-specific data necessary to perform their functions effectively and efficiently. This promotes transparency where necessary while maintaining confidentiality where required. The levels of serialization include level 1 (device), level 2 (line), level 3 (site), and level 4 (enterprise). Other implementations can include more or fewer levels than the example in FIG. 4. At level 1, the serialization data for the items can be obtained from manufacturing equipment, by interacting with interfaces of existing or new packaging equipment. At level 2, the serialization data for the items can be obtained from line equipment and the system 102 can track the serialization data integrity throughout the packaging lot or batch. At level 3, the serialization data for the items can include event data, site-level master data, serial number management data, event reporting data, and data for offline serialization packing operations. At level 4, the serialization data for the items can include connectivity data that can be used to comprehensively track and trace the items and ensure compliance integrations. Furthermore, the system 102 can implement data synchronization mechanisms between the different levels of serialization to maintain data consistency and provide an accurate representation of the supply chain's serialization status.

In some implementations, the levels of serialization can include unit level, bundle level, case level, pallet level, or a combination thereof. In some implementations, the system can support multiple serialization workflows meeting a wide array of packaging scenarios and serialization requirements at unit level, bundle level, case level, and pallet level. For example, at the unit level, the serialization data can include data for one or more of the following: carton print and verify operations, bottle labeling operations, manual print and scan operations, bottom/top code association for bottles, third-party camera interface, etc. At the bundle level, the serialization data can include data for one or more of the following: labeled bundles, virtual bundles, bundle group reads, bundle infeed reads, integrated bundle label printer, remote bundle label printer, etc. At the case level, the serialization data can include data for one or more of the following: automatic casepackers, manual case packing operations, semi-automatic casepackers, manual print and scan (no aggregation), pack by layer, case infeed reads, etc. At the pallet level, the serialization data can include data for one or more of the following: manual palletizing, automated palletizing, end of line information, central information, etc.

Thus, instead of depending on multiple vendors for the levels of serialization, full stack serialization for all the levels can be performed by a serialization module from the same vendor. The serialization module can include a configurable solutions library, can be package equipment agnostic, e.g., having the capacity to retrofit, and/or can include reusable validation packages, e.g., templates, assessments, traceability. The serialization module can provide transparency in pricing, e.g., providing full project scope pricing instead of partial project scope pricing.

In some implementations, the system can receive item authentication data and end-to-end item trace data from computers throughout the supply chain via a global communication network. Furthermore, the system 102 can integrate blockchain technology to ensure the integrity, security, and traceability of items in the supply chain. Each item can be assigned a unique, unalterable identifier that is recorded on a decentralized and secure blockchain ledger. This ensures that the information related to each item is immutable, providing a reliable and verifiable record of each item's journey through the supply chain, thereby enhancing trust among stakeholders and effectively eliminating counterfeiting and unauthorized alterations. The computers can be dedicated computer systems or smartphones. The item authentication data can be used to validate the identity of the items moving in a supply chain. The end-to-end trace data can be used to identify the locations of the items at specific times as the items move in the supply chain. In some implementations, one or both of the item authentication data and the end-to-end item trace data can be electronic fingerprints 124. Computer(s) at each location in the supply chain can perform authentication on the items and can generate corresponding item authentication data for the location. Computer(s) at each location in the supply chain can trace the items and can generate item trace data. Item trace data generated at the locations in the supply chain can be combined to generate the end-to-end item trace data. The supply chain can involve locations at different regions in the world. The network 104 can be a global communication network, and the computers throughout the supply chain can send the item authentication data and the end-to-end item trace data via the global communication network.

In some implementations, the system 102 can include a production line management system and the system 102 can obtain the end-to-end item trace data from a production line management system. The production line management system can be implemented using one or more details from U.S. Pat. No. 8,190,279, which is hereby incorporated by reference in its entirety. The production line management system can be employed to uniquely identify items and enable the tracking of those items through a supply chain, thereby minimizing diversion and counterfeiting while supporting visual inspections and I/O operations, which further supports the packaging of both serialized and non-serialized products. The system can provide precise, real-time inspection results using a combination of, for example, optical character verification (OCV), optical character recognition (OCR), bar code, print and general quality inspections, and other techniques apparent to those skilled in the pertinent arts in light of the disclosure herein.

In some implementations, the system can identify items by electronic fingerprints generated from captured images of marks on the items using computer image processing. For example, the system 102 can obtain electronic fingerprints 124 from the supply chain. Electronic fingerprints can include marks, lot numbers, expire dates, product identification, or a combination of these. In some implementations, an electronic fingerprint can be a digital representation of apparent mark print variations that differentiate items. For example, a mark 140 on an item 110 can have unique variations resulting from formation of the symbol on the item, e.g., as a result of the specific printer used. The present systems and techniques can be implemented using one or more details from U.S. Pat. No. 10,061,958, which is hereby incorporated by reference in its entirety. The system 102 can employ advanced image recognition algorithms and machine learning models to accurately analyze the electronic fingerprints and match them against reference data, facilitating efficient identification and verification of the items in the supply chain.

The system 102 can identify the items 110 using an authentication process based on the electronic fingerprints. For example, a manufacturer 108 can create electronic fingerprints 124 that includes a unique product signature. Because each item 110 can have a unique electronic fingerprint 124, each item can have a unique identity that is non-additive and cannot be counterfeited. For example, the electronic fingerprints 124 can be associated with pallets and shippers during the packaging and shipping process. The manufacturer 108 can send the electronic fingerprints 124 to the system 102 via the network 104 to a secure cloud server. The system 102 can save the electronic fingerprints 124 in the secure cloud server that can be connected to the system 102. When another location in the supply chain receives the items, a device at the location can perform authentication on the received items. For example, a distributor, a retailer, or a customer can perform effectively instant authentication using a smartphone, a computer, or another device. The device can capture an image of the received item, send the image to the secure cloud server. The secure cloud server can perform authentication using the saved electronic fingerprints 124, e.g., by comparing the saved electronic fingerprints with fingerprint information obtained from the image. Using the above authentication process, the system can perform anti-counterfeiting and product authentication. For example, the system can prevent product diversion at distributors, can confirm product authenticity at retailers, and can enable engagement and foster brand loyalty at the customer end.

The data is analyzed 304 to produce information while at least a portion of the items move through the supply chain. For example, the system 102 can process the data 120 regarding the items 110 and can generate information 128 of the supply chain. While at least a portion of the items 110 move through the supply chain 106, the system 102 can analyze the event data for events that happen at different locations of the supply chain and can generate information 128 of corresponding locations of the supply chain. In some implementations, as the items 110 move through the supply chain, the system 102 can continuously receive additional data regarding the items and can generate updated information using the additional data.

For example, the system 102 can use end-to-end item trace data to generate information that helps manufacturers to track and trace products through the supply chain. Information 128 generated using the end-to-end item trace data can include serial number usage, disposition events information (disposition counts, by lot and product/material), serial number pool status, serial number allocation, European Medicines Verification System (EMVS) status, Verification Router Service (VRS) activity, material/product configuration, job queue performance, and distribution leaderboard.

In some implementations, the system can analyze data about at least a portion of the items that are moving through the supply chain and can analyze historical data about another portion of the items that have fully passed through the supply chain, which were discarded before fully passing through the supply chain, or both. For example, the manufacturer can send three pallets of the items 110 through the supply chain 106. The first pallet has fully passed through the supply chain and was sold to consumers 118. The second pallet was discarded at the retailer 116 and has not fully passed through the supply chain. The system 102 can save historical data 126 about the first pallet and the second pallet, e.g., in a database installed on a computer. The system 102 can receive data regarding the third pallet while the third pallet moves through the supply chain. The system 102 can analyze data about the third pallet that is moving through the supply chain and can analyze the historical data 126 about the first pallet, the second pallet, or both.

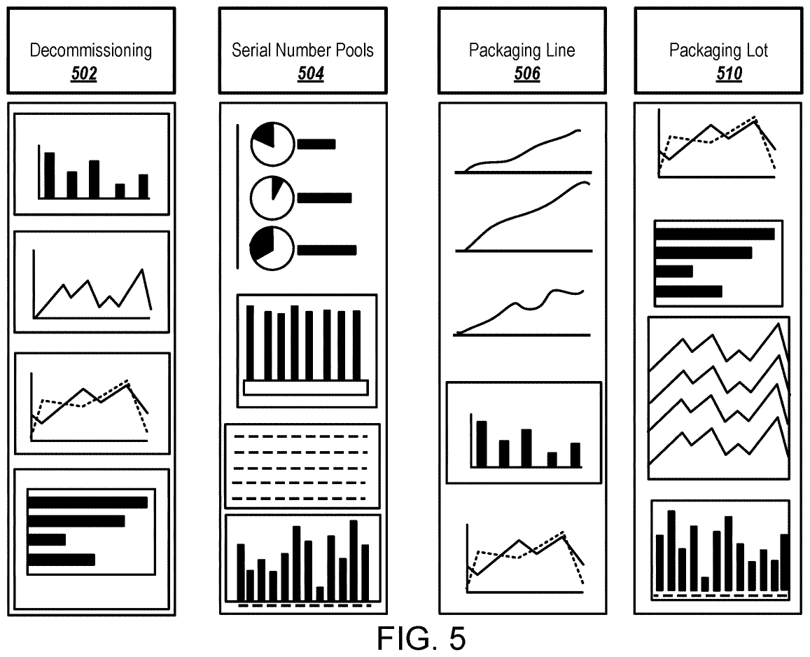

In some implementations, the produced information can include decommissioning information, serial number pool information, packaging line performance information, and packaging lot information. FIG. 5 shows examples of information of a supply chain, including decommissioning information 502, serial number pool information 504, packaging line performance information 506, and packaging lot information 510.

A visualization of the information is provided 306, and the information can be usable to identify one or more changes to make in at least one portion of the supply chain to improve the at least one portion of the supply chain. The visualization can include reports, diagrams, thresholds, metrics, tables, trends, etc. In some implementations, the visualization can include one or more dashboards 132 displaying the information. For example, referring to FIG. 5, the plots and diagrams under each type of information (e.g., decommissioning information 502, serial number pool information 504, packaging line performance information 506, and packaging lot information 510) can be the visualization of the information.

The information can be usable to identify one or more changes to make in at least one portion of the supply chain to improve the at least one portion of the supply chain. A portion of the supply chain can be, for example, a single location or a set of two or more locations. Changes to the supply chain can be, for example, an increase in throughput and/or efficiency on a production line, e.g., by calculating and tracking production losses, reducing downtime, increasing equipment performance, improving product quality, etc. For example, changes to lot configuration at a manufacturer can reduce the number of decommission events happening at the manufacturer. In some implementations, the system can provide visualization of analytics, e.g., packaging lot statistics, across multiple sites, lines, production and packaging levels. The visualization can show patterns that are not obvious by viewing individual Good Manufacturing Practice (GMP) or regulatory reports. For example, patterns such as how line speed affects rejected product generation or dips in line efficiency at similar times of the day, only become apparent when comparing weeks and months' worth of data in the same view. In some implementations, the system 102 can also predict future occurrences in the supply chain, such as potential bottlenecks, inefficiencies, or failures, using machine learning algorithms based on the historical data and real-time data. This predictive feature can suggest preventative measures to avert predicted supply chain issues, providing a more robust and uninterrupted supply chain. In addition, in some implementations, the system can estimate the optimal rate of production for different lines based on past performance, current status, and future trends of the supply chain. This can provide valuable insights for optimizing efficiency and throughput while minimizing potential issues.

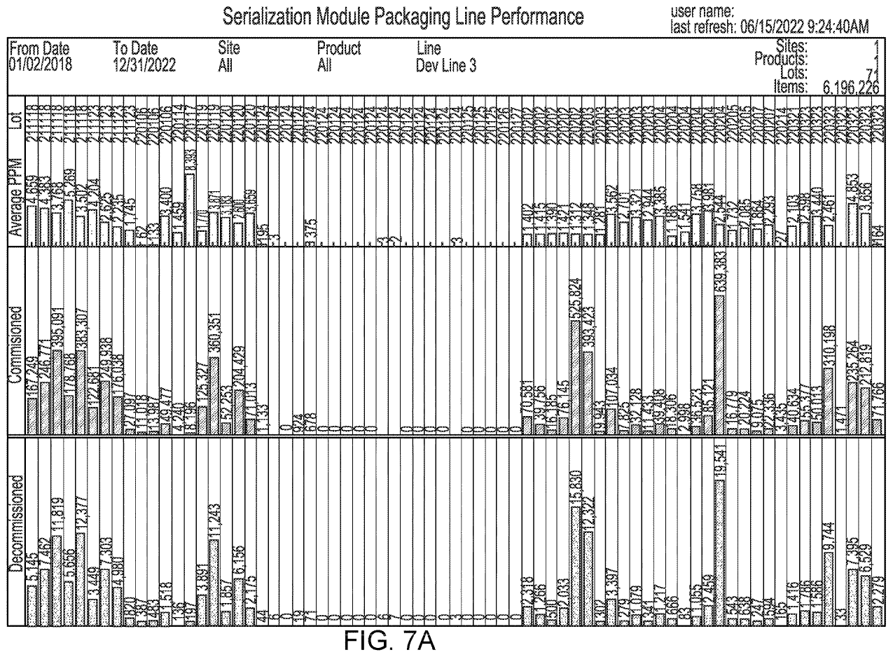

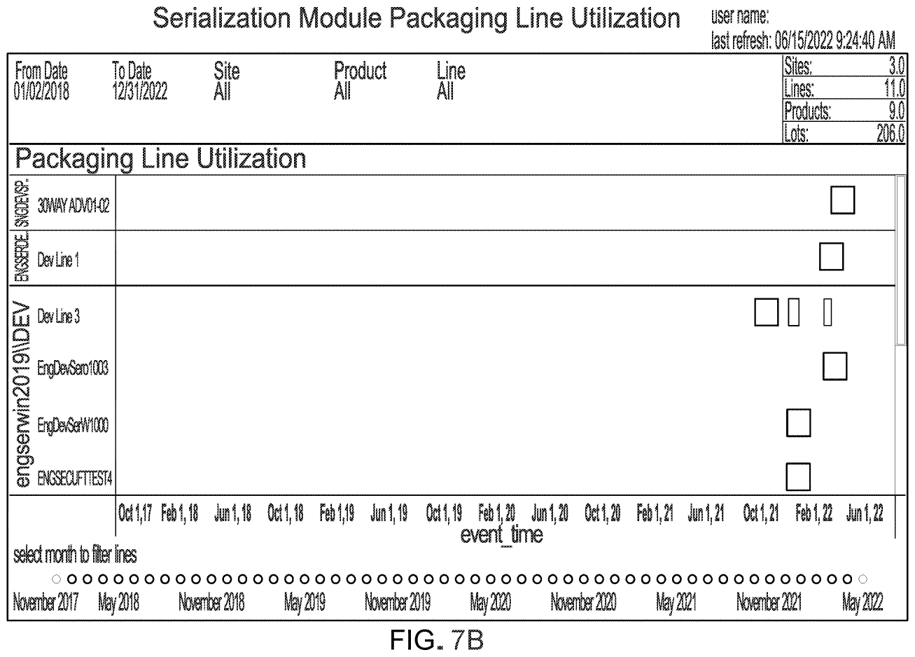

For example, FIG. 7A visualizes information for average part per minute (PPM). A part can be a carton, a label, a case or other packaging related item. Average PPM provides a gross average of all the things produced. A packaging line is designed to run at a particular rate. The dashboard in FIG. 7A displays the average PPM processed for the lot that was running on the packaging line. When the PPM is low, the line is running slow, and it is of concern. Potentially, there are a lot of issues on the line that can cause low PPM. When the PPM is low, this would indicate that the line and lot need further investigation, especially if low average PPM happens back-to-back or repeatedly. When PPM is high with high decommission counts, the line is going too fast and resulting in too many decommissioned items. This would indicate that the line needs to be redesigned. Thus, the three data points (PPM, commission, decommission) per lot on the packaging dashboard provides further insight into aberrations in one area, when compared to other areas.

Based on the analysis of average PPM and decommission counts, users can identify if the packaging line is running too fast or too slow. For example, through an interface, users can take corrective action by adjusting the production speed to optimize efficiency and minimize decommissioned items. Moreover, the system can utilize the predictive feature to anticipate if the packaging line will run too fast or too slow in future instances. It can do so by processing historical and real-time data through machine learning algorithms. Predictive analytics can then guide users on proactive adjustments that can be made in advance to optimize line speed, thereby preemptively addressing efficiency and decommissioned item concerns. As another example, users can investigate the root cause, such as malfunctioning equipment or faulty components. Through the interface, they can create maintenance requests, schedule equipment repairs, or order replacement parts to resolve the issue and ensure smooth operations.

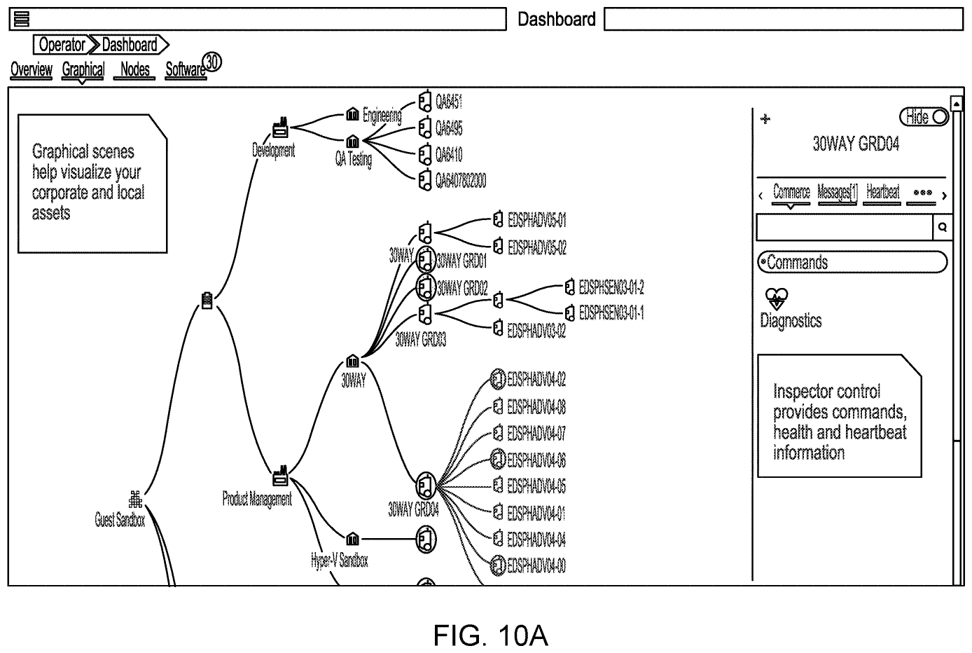

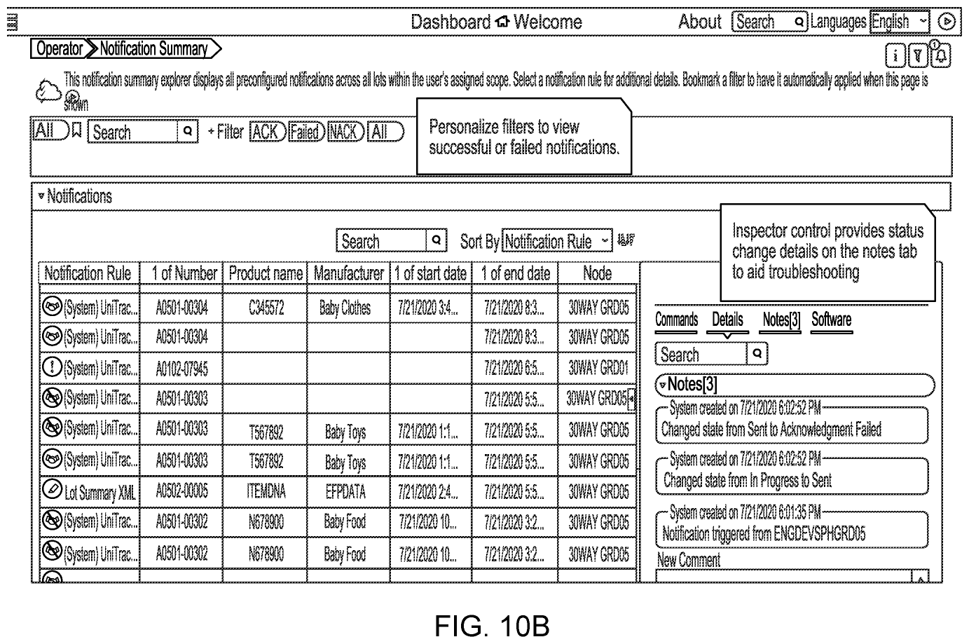

In some implementations, a user of the system 102 can determine a change to make in at least one portion of the supply chain to improve the at least one portion of the supply chain. Additionally, the system 102 can proactively predict potential changes needed in the supply chain to improve its efficiency and throughput. This prediction can be derived from historical and real-time data analysis using machine learning algorithms. Thus, the system aids users in making informed, proactive changes, reducing the occurrence of supply chain disruptions. In some implementations, the system 102 can display a recommended change to at least one portion of the supply chain that can likely improve the at least one portion of the supply chain. FIG. 10B is an example dashboard to display notification summary. The notification summary can be usable to improve the supply chain. For example, a user can review the failed notifications in order to take corrective action. As another example, the system can recommend one or more corrective actions to improve a portion of the supply chain.

In some implementations, the system can send distinct dashboards for displaying (i) decommissioning events for sites, products and packaging lines, (ii) serial number pool status and serial number allocations, (iii) packaging line utilization and performance, and (iv) packaging lot/batch details including settings, runtimes, events, counts and decommission reasons. In some implementations, the system can send distinct dashboards for displaying production details, including cleaning, maintenance, setup, material loading, and material delays.

FIGS. 6A-6B show examples of dashboards for displaying decommission events. The decommissioning dashboard visualizes decommissioning events for sites, products and packaging lines. FIG. 6A is an example dashboard for displaying decommission summary for a period of time, e.g., from Jan. 1, 2018 to Dec. 31, 2022. With regard to the decommission summary, the following is displayed: top sites based on count of decommission events; top products based on count of decommission events; top lines based on count of decommission events; count of decommissioned events by month for each specified year. FIG. 6A displays top 10 sites, top 10 products, top 10 lines by decommission events. FIG. 6A also displays a bar chart showing annual decommission events by year and month. The bars can provide interactive input to the dashboard. When a bar is selected, the data in the above three boxes can be filtered based on the selected month(s).

FIG. 6B is an example dashboard for decommission events by line and package level, displaying reasons for the decommission events and their corresponding product, line, package, location, and counts. With regard to the decommission events by line and package level, the following can be displayed: decommission reasons by line, product and packaging level; top lines based on count of decommission events. In some implementations, the dashboards for decommission can include annual decommission, and decommission event trends. With regard to the annual decommission, the following can be displayed: decommission reasons by line, product and packaging level; count of decommissioned events by month for each specified year. With regard to the decommission event trends, the following can be displayed: counts of decommission reasons; decommission reasons by hour; decommissioned reasons by minute.

FIGS. 7A-7B show examples of dashboards for packaging line utilization and performance. A packaging line is a physical construction including physical conveyor belts, packaging machines, printers, cameras, and/or computers. The packaging line performance dashboard visualizes packaging line utilization and performance. FIG. 7A is an example dashboard for displaying packaging line performance, including average processed parts per minute (PPM) by lot, count of items commissioned by lot, and count of items decommissioned by lot. Thus, the dashboard in FIG. 7A can provide drill-down, point and click visibility to PPM throughput on lots, allowing performance normalization using this type of cross-lot data. The dashboard shown in FIG. 7A is useful for users responsible for packaging line automation engineering and production planning, responsible for packaging line, overall installation of packaging lines, architecture within the site, changing equipment, doing upgrades, scheduling software hardware upgrades. The users can see how well the line is running, find low performing lots/lines that are not running at the optimal specification, which need an upgrade or improvement, and can perform research to make lines/lots more productive.

FIG. 7B is an example dashboard for displaying packing line utilization based on month and year and a timeline of lot activity on selected lines. In some implementations, through connected and consolidated cross-line data, a dashboard can include information for multiple lines and their production data that provides actionable insight to the multiple lines. In some implementations, the dashboards for packing line can include lot performance profile commissioning, and lot performance profile decommissioning. With regard to the lot performance profile commissioning, date/time-based commissioning trend of items by packaging level for a selected lot can be displayed. With regard to the lot performance profile decommissioning, date/time-based decommissioning trend of items by packaging level for a selected lot can be displayed.

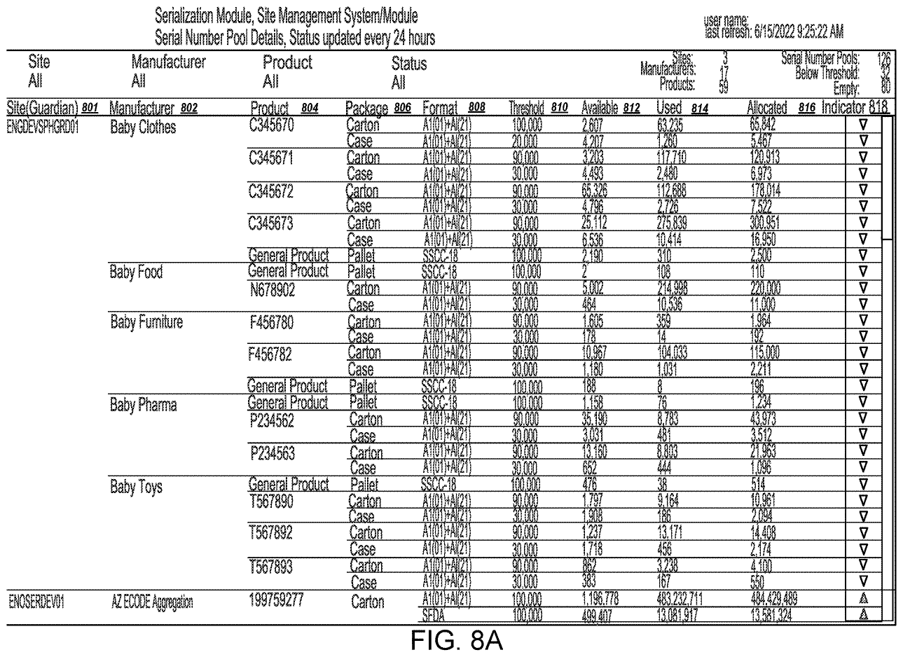

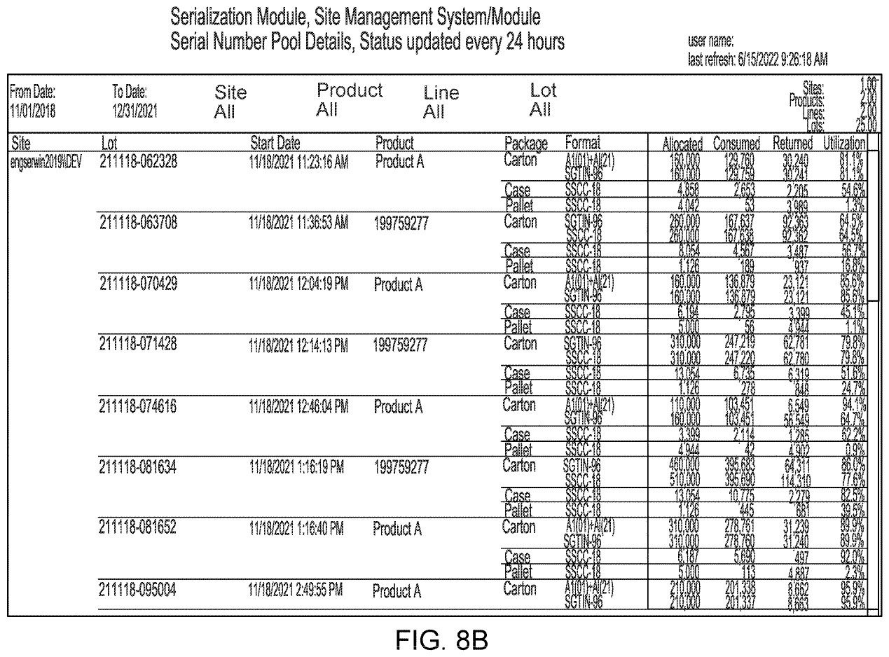

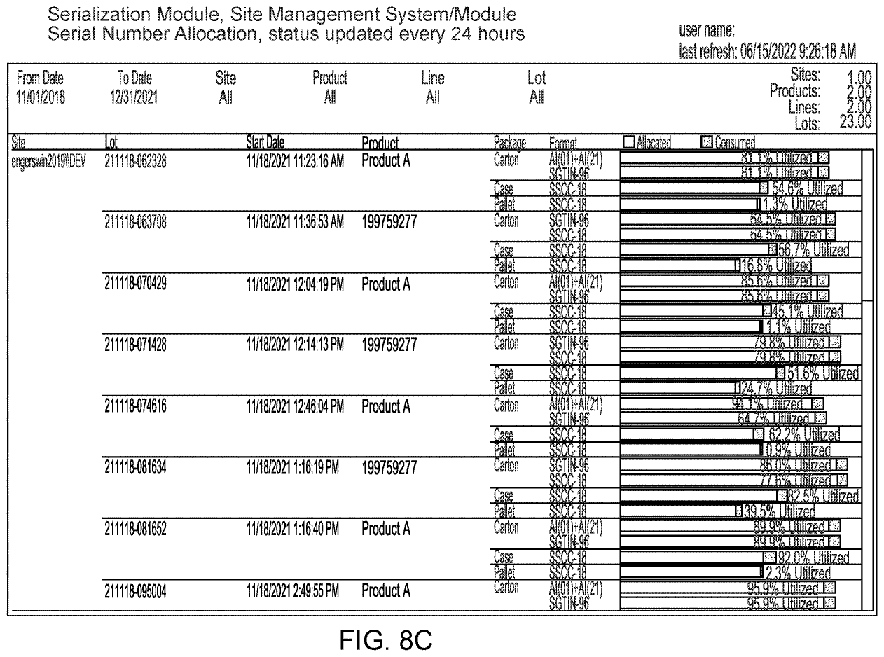

FIGS. 8A-8C show examples of dashboards for serial number pool status and serial number allocations. The serial number pool dashboard visualizes serial number pool status and serial number allocations. FIGS. 8A and 8B are examples of dashboards for displaying serial number pool status details and they can be updated at every period of time, e.g., every 24 hours. The displayed serial number pool detail including threshold, available, used and allocated serial numbers, and they are displayed by site, manufacturer, product packaging level and format. Users are able to filter on site, manufacturer, product and allocation status. FIG. 8C is an example dashboard for displaying serial number allocation information including sites, lots, start date, product, package, format, bars for allocated and consumed serial numbers, and percentage of utilization. The allocated, consumed and returned serial numbers are displayed by site, lot, lot start date, product, packaging level and format. Users are able to filter on date processed, site, product, line and lot. In some implementations, the allocated and consumed serial numbers can be displayed graphically represented by site, lot, lot start date, product, packaging level and format. Users are able to filter on date processed, site, product, line and lot.

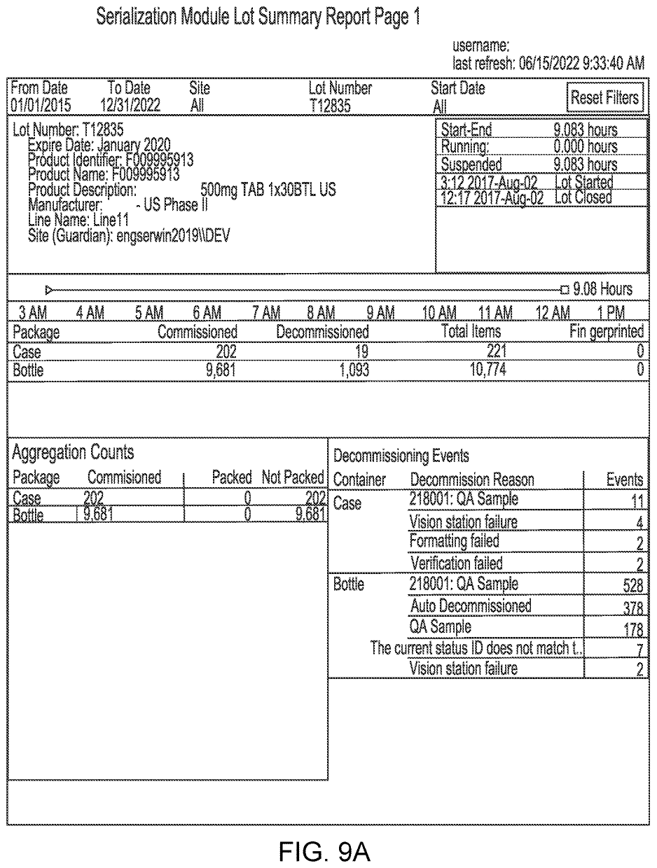

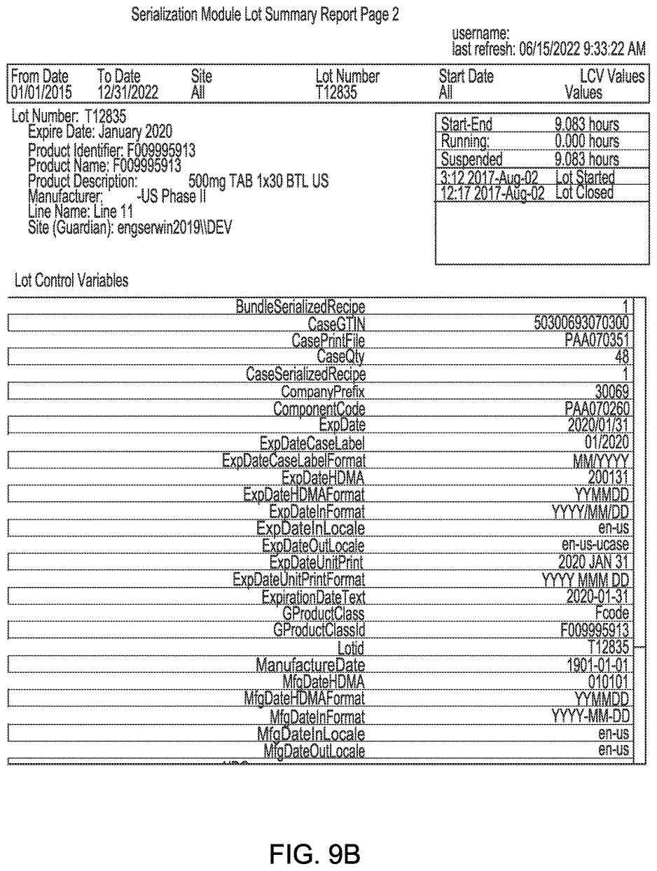

FIGS. 9A-9B show examples of dashboards for packaging lot/batch details. A packaging lot is a batch of products. For example, anytime a product from the pharmacy is obtained and has a lot of expiration date on it, the lot number is a packaging lot for all of the products that were packaged for that particular production lot/batch. The packaging lot information dashboard visualizes packaging lot/batch details that include settings, runtimes, events, counts and decommission reasons. FIG. 9A is an example page 1 of a Lot Summary Report for a particular lot. The report contains summarized information for a selected processed lot. Users are able to filter on date processed, site, and the start date of the selected lot. FIG. 9A displays lot summary details, such as commissioned and decommissioned counts for different container types (e.g., cases and bottles), aggregation counts, and decommission events by the container types. For example, with regard to lot summary details, the following can be displayed for the selected lot: site, line, manufacturer, product; when lot started, suspended, ended; lot running time; lot suspended time; number of items commissioned, decommissioned, aggregated and fingerprinted by packaging level; and number of decommissioning events by packaging level and decommissioning reason.

FIG. 9B is an example page 2 of the Lot Summary Report for the particular lot and displays a list of lot control variable (LCV). With regard to the lot summary of loss control variable, the following can be displayed for the lot selected in the lot summary details section: lot control variables with values; and lot control variables that are not applicable.

In some implementations, the system can send distinct dashboards for displaying a vault for key files. There can be numerous files associated with setting up and operating lines of a supply chain. The system can determine a place to save and organize archives, project documents, printer templates, programmable logic controller (PLC) programs, device configurations or any type of files and the place can be a single secure location. For example, the system can store archives and project related documents in a single location. Files can be tagged with change control numbers or user defined labels for faster searching through a user interface of a dashboard. For example, the dashboard can include personalized filters to show the desired information. Custom labels can be created on individual documents and publish status can be updated on the individual documents. A user can view file details and create links to external reference documents.

In some implementations, the system can capture and centralize data about multiple lines and sites. The system can provide actionable reporting about line operations across manufacturing and packaging facilities. The real-time supply chain visualization and control system can provide pre-configured reports and/or the ability to develop custom reports.

In some implementations, the system can identify 308 trends and potential threats based on predetermined threshold values related to at least one of decommissioning information, serial number pool information, packaging line performance information, and packaging lot information. For example, referring to FIG. 8A, the system can obtain predetermined threshold values for serialization numbers count for each type of product and for each type of package (e.g., carton or case). The system can compare available serialization numbers to the threshold values to determine a potential threat of insufficient available serialization numbers.

In some implementations, the system can generate an interactive, graphical view for visualizing data related to a serialization number pool. For example, the graphical view can be on a geographic representation, such as a world map. The serialization number pool can represent serialization number inventory and the serialization number inventory can be obtained from a government authority or a trading partner. For example, the system can obtain packaging data focused on meeting GMP and regulatory packaging requirements. Validation efforts can be focused on the accuracy of this data to meet these requirements that allow packaging sites and lines to stay in operation. Some validation efforts can be costly and time consuming. With the systems and techniques described herein, site servers and packaging line systems can be modified to keep them current with the regulations, and packaging operations can generate and collect data for GMP and regulatory requirements. Therefore, the present systems and techniques can take data collected for serialization regulatory purposes and can determine the performance of the packaging line using the regulatory collected data.

In some implementations, the visualization can include serialization number pool visualization including counts data based on a site, manufacturer, product and package for allocated serialization numbers, used serialization numbers, available serialization numbers, decommissioned serialization numbers, d serialization format, serialization numbers count threshold and a visual indicator for indicating whether the available serialization numbers are above or below the serialization numbers count threshold. FIG. 8A is an example dashboard that includes an interactive, graphical view for visualizing data related to a serialization number pool. The example dashboard includes counts data based on site 801, manufacturer 802, product 804 and package 806, allocated serialization numbers 816, used serialization numbers 814, available serialization numbers 812, decommissioned serialization numbers, d serialization format 808, serialization numbers count threshold 810 and a visual indicator 818 for indicating whether the available serialization numbers are above or below the serialization numbers count threshold. In some implementations, the serialization numbers count threshold can be a predetermined value set by a customer. For example, the serialization numbers count threshold 810 can be a predetermined value set by a customer.

In some implementations, the system can include a predictive analytics module capable of leveraging historical data to forecast future trends, potential failures, and successes in various aspects of the operations. The predictive analytics module can utilize machine learning algorithms and statistical models to provide predictive insights based on data from decommissioning events, packaging line utilization, serial number pool status, and packaging lot/batch details. This predictive module can provide, for example, foresights into potential decommissioning events, expected serial number allocations, expected line performance, and anticipated packaging lot/batch details. By enabling such foresight, the system allows users to adopt proactive measures to mitigate potential issues or to seize favorable trends, thus enhancing the efficiency, productivity, and cost-effectiveness of the operations.

For example, the allocated column 816 of FIG. 8A shows how many serial numbers have been set aside but not used and should not be more than “available” to use. The triangles in FIG. 8A are an indicator for when “available” is above or below the “threshold” value. When the indicator is a triangle that points down, the customer can procure more serial numbers. When the indicator is a triangle that points up, the customer does not need to procure more serial numbers. Procurement of serial numbers can take some time, especially when the serial numbers are provided by a regulatory or government entity. Thus, the systems and techniques can provide visibility to procurement needs ahead of time, ensuring the efficiency and smoothness of the supply chain. In some implementations, the system can include an alert mechanism capable of issuing warnings in response to detected anomalies or potential issues in the operations. The alert mechanism can analyze the gathered data from decommissioning events, packaging line utilization, serial number pool status, and packaging lot/batch details, and upon identification of significant deviations from expected patterns or thresholds, issue alerts to the relevant personnel in real-time. For example, a sharp increase in decommissioning events, a sudden drop in packaging line performance, or a significant reduction in the available serial numbers in the pool can trigger an alert. These alerts can prompt quick intervention and rectification, thus mitigating operational disruption and maintaining productivity and efficiency.

In some implementations, the system can send distinct sets of information about a specific item to two or more of a manufacturer, a packager, a distributor, a retailer, and an end consumer. Referring to FIG. 1, the system 102 can send information 122 of an item to two or more of a manufacturer 108, a packager, a distributor 112, a retailer 116, and an end consumer 118. For example, the system 102 can send decommissioning information of a pallet of items to a manufacturer 108 and a distributor 112. As another example, the system can send a dashboard of packaging information to distributors and the distributors can get visibility into the efficiency and utilization of their packaging operations.

In some implementations, the system can generate an interactive, graphical view of an organization's sites, environments, data sources, machines, and site servers and packaging line systems. FIG. 10A shows an example dashboard that includes an interactive, graphical view of an organization's sites, environments, data sources, machines, and site servers and packaging line systems. For example, lines and devices can be consolidated and visible in one management view shown in FIG. 10A. The graphical scenes can help visualize an organization (e.g., a corporate) and its local assets, such as machines and site servers for development (including engineering and QA testing) and product management. The right side of the dashboard in FIG. 10A displays one or more inspector controls. The inspector controls can provide commands (e.g., diagnostics commands) and health and heartbeat information. Through the dashboard, the system can issue commands to nodes, components, or modules of a packaging line system. For example, a diagnostic command can be sent to a node to run a diagnostic program and send results back to the system. As another example, an archive command can be sent to the node to create a backup of its configuration and return the backup file to the system.

FIG. 10B shows another example dashboard that includes an interactive, graphical view. FIG. 10B shows an enterprise notifications dashboard that can provide visibility to the actions on the supply chain managed by the organization, including the lines. For example, notifications can be quickly sent to operators via text messages. The dashboard includes personalized filters to view successful or failed notifications. A viewer of the dashboard can focus on failed notifications in order to take corrective action. The dashboard includes inspector controls on the right side. The inspector controls can provide status change details on the notes tab to aid troubleshooting.

In some implementations, the interactive, graphical view can include representations of devices installed on a production line of an organization. The devices displayed in user scenes of the graphical user interface can include cameras, printers, barcode scanners, and sensors installed on the production line. For example, the interactive, graphical view can include representations of cameras, printers, barcode scanners, and sensors installed on the production line of the organization. FIG. 2 shows an example of a production line 200. Different types of devices, such as cameras 214, printers 216 (e.g., laser printer 222), scanners (e.g., hand scanner 218 and RFID encoder/reader 220), and sensors (e.g., cameras 214, a temperature sensor, a light sensor, or a motion sensor), can be installed on the production line 200. The system 102 can display a visualization of representations of the devices in the production line in an interactive, graphical view. FIG. 10A shows an example dashboard that includes an interactive, graphical view of an organization's local assets. The devices installed on the production line 200 can be the “local assets” represented in FIG. 10A.

The present systems and techniques provide end to end serialization and, in the process, generate data that can be used for analyzing overall equipment effectiveness (OEE). In examples, OEE is a best-practices metric that indicates how well a manufacturing operation is utilized compared to its full potential. To achieve this, key performance losses and bottlenecks are identified to calculate and then improve OEE. The OEE method measures line productivity based on three key performance indicators: 100% availability (no stop time), 100% performance (as fast as possible) and 100% quality (no faulty output). OEE is a standard way to measure manufacturing productivity composed of three key performance indicators (KPIs), availability, performance and quality. Availability assesses real versus planned production time. Performance considers real versus theoretical maximum line rate. Quality addresses the ratio of good versus total products produced. The systems and techniques described herein can further provide real-time monitoring of line key performance indicators (KPIs) for packaging operations. This allows for continuous tracking and analysis of KPIs such as production speed, equipment downtime, and product quality, providing immediate insights for performance improvement.

Best in class manufacturing plants may achieve 85% OEE rates. Many companies don't have the information they need to calculate, let alone track effectively. A key reason is the cost and difficulty in capturing the data and time for it to make a difference. Improvements can be made to increase productivity only when data is tangible and easily accessible.

An OEE tool can provide accurate data about a site's main production losses. By pinpointing contributors to downtime, low performance and poor quality, corrective action can be prioritized. Before implementing a continuous improvement program, typically OEE is 50-60%. Through tools that allow fact-based incremental changes over time, manufacturers can achieve OEE levels of 85%. A manual OEE solution, such as having operators fill in worksheets, is inexpensive and quick to implement, but the data is often unreliable and very difficult to consolidate. At the other extreme, a sophisticated OEE solution from an industrial automation provider can take months or years to design and implement, call for heavy investment, and extensive production shutdown.

However, the main drawback to relying on OEE alone is the lack of granularity to the metrics provided by OEE standards and the focus on particular equipment versus the entire production line. Further, OEE formulas often rely on the assumption that a production line or production machine is running 24/7 packaging operations. That is, OEE calculations assume ongoing and constant equipment utilization. Thus, OEE calculations need to be improved and adapted to packaging operations which, for example, might run a packaging line two times a week. A typical OEE calculation applied to such a packaging line might incorrectly indicate equipment inefficiency because the equipment is sitting idle for five out of seven days a week. OEE results in this case are obscured by a typical practice in packaging lines where equipment is not being utilized all of the time.

For example, a standard OEE software solution might be useful to upper management that can track whether total production went from 85% to 82% but that metric or score is too vague to provide insight or context into the reason for the change in the score. Such issues can be reduced or eliminated by the systems and techniques described in this specification by providing insight and granularity to save time in determining root causes for production issues, address events when they happen, notifications to users when production events are happening that need to be addressed or resolved, which in turn improves output, ability to make faster and more accurate corrections and minimize downtime or loss. The systems and techniques described herein offer an interactive, graphical view for easy visualization and data interpretation. This allows users to explore and analyze OEE metrics in a visually intuitive manner, providing contextual information and facilitating the identification of root causes for production issues. The detailed, real-time data collection and storage capabilities, including timestamps for items inspected on the packaging line, enable accurate tracking and analysis of events, enabling proactive decision-making and timely corrective actions.

Compliance with serialization regulations is more involved than just putting a serial number on a package. At the Line level, there are complexities around manual versus automated lines, existing versus new lines, and the varied nature of packaging equipment with the various Original Equipment Manufacturer (OEM) solutions in the industry. At the site and enterprise level, the electronic serialized product data not only needs to match the physical, but can also be tracked in the supply chain through multiple channels and handle supply chain events like returns, damages, recalls, etc. Serialization is now a four-level software stack. Looking for vendors that can provide the full range of bottom-up Device and Line-level software as well as integrated top-down Enterprise and Site-level software can be challenging. The systems and techniques described in this specification facilitate a single-vendor approach to addressing these levels and can ensure tight integration of the solution, facilitate data communication, and decrease overall project risk.

The product serialization and supply chain management software/system described in this specification can reduce risk and deliver rapid deployments through solution standardization. The present systems and techniques enable a serialization solution that can meet short and long-term needs. The product serialization and supply chain management software/system is scalable as operations grow, as regulations change, and companies enter new markets. The product serialization and supply chain management software/system can provide off-the-shelf, configurable product that does not rely on customized or made-to-order components. The present systems and techniques enable a modular approach that is productized, configurable and expandable. It is considered a good automated manufacturing practice (GAMP), compliant with GAMP®5: A Risk-Based Approach to Compliant GxP Computerized Systems, published by the International Society of Pharmaceutical Engineers in 2008. In examples, the product serialization and supply chain management software/system is a Category 4 Configured Product. Its configurable serialization software is designed with elements that can be assembled and realigned to quickly accommodate changing demands. In contrast, customized solutions are rigid, making them difficult and costly to modify. When requirements change, it can be necessary to reengage vendors and incur expensive rewrite, revalidation and re-training costs-but not with the product serialization and supply chain management software/system as described here. The product serialization and supply chain management software/system can include a solution library. The solution library is a library of prepackaged modules to meet a wide array of packaging scenarios and serialization specifications, supporting multiple serialization workflows.

Successful serialization, particularly of mass-produced items, involves the integration of multiple systems, including enterprise software, printer or tagging technologies, reader systems, and production machinery, to apply and verify unique serial numbers. Serialization enables identification of products. For many consumer-packaged goods, particularly those that have a long shelf-life, the individual units are essentially interchangeable. In this case, absent other supply-chain considerations, identification of the product type is enough to identify any instance of the product. Other products, including ones that are perishable and ones that are subject to regulation like pharmaceuticals, are granted a higher level of differentiation through the assignment of a lot or batch number. A lot number sets apart a group of the product, including up to several thousand units, distinguishing them from units in other batches.

The use of a lot number enables some additional control. Other attributes, like an expiration date, can be associated with the lot. The products in the lot could conceivably be tracked as they move within the distribution system, assuming that the lot number is captured and reported at waypoints in the supply chain. The designation of the lot can also facilitate some control within the supply chain, including reverse logistics efforts such as recalls.

In examples, the present systems and techniques enable an identification of individual units. To further differentiate between instances of a product, each item can be assigned a unique serial number. In the past, economics only supported such an effort for higher ticket items like appliances, consumer electronics or cars. However, as related manufacturing technologies have evolved, it has become feasible to assign numbers to lower-cost items. In parallel with this development, some industries have come under regulations that use unit serialization, particularly pharmaceuticals. Technologies to store, communicate, and share serial numbers, have also developed to complement the application of the numbers.

A unique serial number enables the same measures as a lot number, but of course at a more granular level. An expiration date can be assigned to a serialized object, each individual object can be tracked in the supply chain, and recalls can be keyed on individual serial numbers. The value of serialization increases when any entity in the supply chain—from manufacturers to distributors to retailers to the end user—can read the serial number and identify the object, as supported by the present systems and techniques. Contemporary serialization efforts typically apply standardized methods to the attachment of the serial number (through barcodes, two dimensional symbols, or radio frequency identification (RFID)) and the formatting of the number itself. Such standards pave the way to simplified reporting, track and trace, and other enhancements to the distribution and sale of products. The systems and techniques described in this specification facilitate detailed, real-time data collection and storage, including timestamps, to ensure accurate tracking and tracing of products using serial numbers and lot numbers. The real-time, cloud-based system collects and analyzes critical data for smooth operations and visualization, allowing for seamless reporting, track and trace capabilities, and enhanced supply chain management. The interactive, graphical view provided by the system enables easy visualization and interpretation of the collected data, empowering users to gain actionable insights and make informed decisions.

Sometimes, packaging line data is disconnected. In examples, an organization that provides supply chain safety and brand protection can have insight into various aspects of the supply chain. Using the organization as an example, network connectivity can be observed from enterprise systems to Level 3 packaging site management server, but rarely visibility to Level 2 line manager and Level 1 machine interface and vision system. Essentially, each line is its own island. Such issues can be reduced or eliminated by the systems and techniques described in this specification.

In examples, the present systems and techniques implement serialization in pharmaceuticals, to support various global regulatory mandates, which have been introduced over the past several years. In examples, the real-time supply chain insight system enables a full range of actionable knowledge in real time to maximize operational excellence. A real-time supply chain insight system collects and stores critical data with minimal effort for access when needed, however it is needed. This enables smoother operations on the packaging line. It is also a cloud-based environment that is easy to implement and maintain.

The present systems and techniques can provide live production visualization that shows production as it occurs, including showing an active line and the lot that is running for a particular product. FIG. 10A shows an example dashboard that includes an interactive, graphical view of an organization's local assets, such as sites, environments, data sources, machines, and site servers and packaging line systems. As parts are created, for example, cartons, the live production visualization in FIG. 10A shows progress. For example, 10,000 cartons have been created, and the view is refreshed in real-time to reflect additional cartons as they are created, as well as how many parts were rejected, for example, 1000 rejected cartons, which is also refreshed live. The visualization automatically updates real time or near-real time, for example, every minute, the counts from the line systems. The visualization can show the counts coming through as they are generated during inspection on the production line. This type of live visualization can be also streamed onto a large TV screen or a kiosk and can automatically refresh and scroll through all of the lines so that users on the site can all have visibility of the live production view. The systems and techniques described herein offer detailed, real-time data collection and storage, including timestamps, to enable the visualization of live production progress and quality metrics. The interactive, graphical view provides an easy-to-interpret representation of an organization's packaging line systems and allows for real-time monitoring of production activities. Users can track the creation of parts, such as cartons, and monitor the rejection counts in real time, empowering them to identify production issues and take prompt corrective actions. The live production visualization enhances transparency and enables effective decision-making for optimized operations.

A fast-moving consumer goods (FMCG) plant, such as a food manufacturer with five lines making between 10 to 300 products a minute with low to medium margins, can benefit from a standard OEE software solution. However, these software solutions can be time consuming and expensive to install and can consume lots of time for enough data to accumulate before getting any actionable insight. Further, once the OEE tool is in place, operator training is vital. Without their buy-in to input downtime reasons etc., managers can get OEE statistics without the insights needed to make the most relevant changes. Such issues can be reduced or eliminated by the systems and techniques described in this specification. Data can be collected for a week and then reviewed with the OEE supplier to evaluate if the configuration needs tweaking. Once the set-up looks correct, the tool can run for at least a month so a true picture can emerge, as OEE can vary by day, employee, and shift. Using the systems and techniques described in this specification, charts indicating production loss areas can help prioritize solutions based on impact, cost, and ease of execution. Done properly, the value of the present systems and techniques can be visible within 3-6 months.

The present systems and techniques can provide production line management and can further support manual case labeling, centralized palletizing, and parent-child associations. Line management can include the commissioning and decommissioning products, the supporting of printers, barcode scanner and RFID readers operating in serialization modes, the real-time management of user defined business, real-time process and product quality checks, the generation of production and serialization reports, and the ability to run both serialized and non-serialized products on the same packaging line, for example. Typically, the performance of packaging and similar lines is managed based on a goal of global consistency across outcomes of the line. For example, a programmable logic controller (PLC) can be programmed to ensure a consistent outcome of an aspect along the line for all items passing through that aspect of the line.

However, such a management and design hierarchy targeted solely to global consistency does not allow for rapid deployment of process updates and/or new equipment and makes line modifications expensive and time consuming. Further, in accordance with this goal of global consistency, steps in a typical process for consumer packaging are not historically integrated, that is, the steps are unrelated from a management and design standpoint, excepting that each step contributes to the goal of global consistency in the outcomes of the line. This lack of integration has historically produced satisfactory outcomes for many lines and can continue to produce satisfactory outcomes so long as the sole goal of the line is to produce all outputs to be the same. However, in the event that outputs need to be consistent, but also unique, that is, uniquely tracked, identified, and/or given a series of unique attributes, such as for serialization of outputs from the line, legacy, non-integrated line management and design tools cannot continue to produce acceptable, or cost-effective, outcomes. In examples, serialization refers to the unique identifier used on a saleable packaging unit or handling unit. The serial number can be stand alone or be associated with product information such as lot, product ID, expiration date or manufacturing date. Such issues can be reduced or eliminated by the systems and techniques described in this specification.

The present systems and techniques provide an integrated line management and design system and method. The system and method are integrated at least in that they allow for unique and highly specific interrelations between and among detailed, hierarchical aspects of the system and method, and more specifically detailed aspects discussed herein below as items, processes, and streams.

The present systems and techniques can provide supply chain visibility, giving a full range of actionable knowledge in real time that can be used to maximize operational excellence all the way through the supply chain. As products move through the supply chain, they generate event data that can drive a wealth of process improvement opportunities. The real-time supply chain insight system is an out-of-the-box solution that provides practical insight and connectivity from the very start of deployment. In examples, the real-time supply chain insight system gives both real-time and historical product data. In examples, the real-time supply chain insight system provides enterprise control and visibility to packaging, serialization, anti-counterfeiting and compliance deployments. The real-time supply chain insight system visualizes actionable insight for the entire production environment, across lines, sites and geo locations at any time, with an up-to-date graphical view of the environment, and is available and accurate. The interactive graphical explorer enables a selection of a node, and the ability to view health information of the node, including all child nodes with their availability. The real-time supply chain insight system enables end-to-end visibility to identify key metrics that can be used to build, measure and improve performance from manufacturing to the marketplace. The real-time supply chain insight system provides data-driven real-time supply chain insight systems.

In some implementations, the present systems and techniques can include a single point of view system/platform, which is a single point of view for monitoring and managing environments (e.g., packaging site management server, fingerprint system, anti-counterfeiting and product authentication system, as well as any supported third-party solution). The single point of view system/platform unlocks data previously unreachable in its current state, to provide visibility and intelligence about systems and operations. The present systems and techniques generate schematics of sites and lines, showing the cloud environment and packaging site management server, line manager, and machine interface and vision system deployed in real-time. Additionally, the present systems and techniques generate a report comparing line or lot production and duration in real-time.

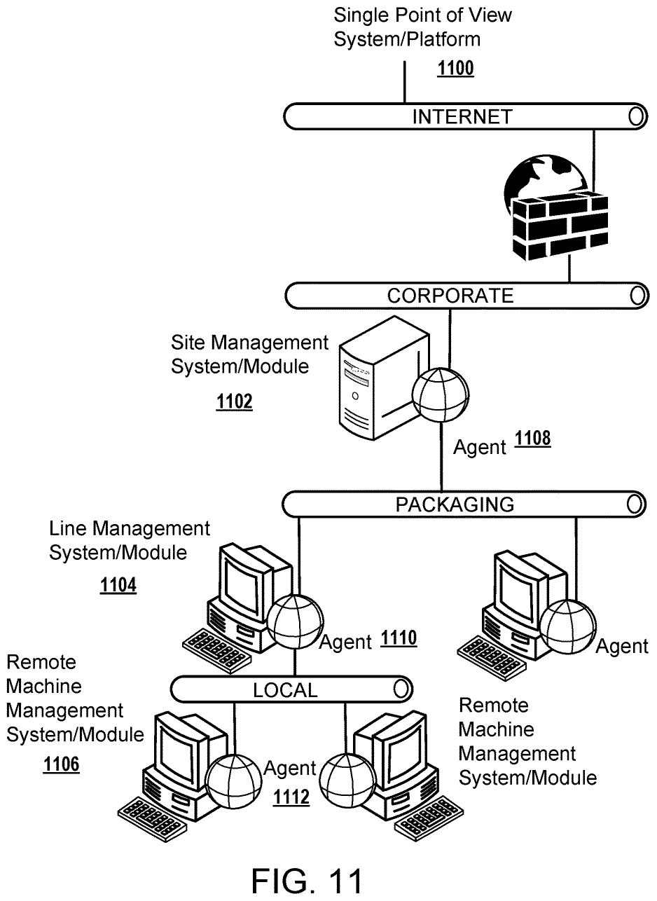

FIG. 11 shows an example of a single point of view system/platform 1100. FIG. 11 shows an example of system architecture components, including a product serialization and supply chain management software/system, packaging site management server 1102, product serialization and supply chain management software/system line manager 1104, product serialization and supply chain management software/system machine interface and vision system 1106, and industrial coding-traceability software.

The packaging site management server 1102 provides lot/batch operations, packaging work order management, serialization management and notification to level 4 systems. The line manager 1104 provides the packaging line operator interface, line setup and data collection for serialized and non-serialized packaging operations. The machine interface and vision system 1106 provides packaging line vision inspection, device communication and reject tracking on the packaging line.

In the example of FIG. 11, the components can perform the following functions. (1) Nodes (packaging site management server, line manager, machine interface and vision system, industrial-coding-traceability-software); (2) Real-time product serialization and supply chain management software/system Lot/Batch production tracking; (3) Health and heartbeat provides node status details; (4) Software management provides accurate version information and recommended update/upgrade path as well as access to release notes; (5) Diagnostic command runs the node specific diagnostic utility and returns the result into a single point of view system/platform; (6) Vault archive command creates a configuration archive and uploads the file directly into the centralized storage system; (7) User defined, corporate and site graphical scenes to visualize the deployments, including Production Explorer; (8) packaging site management server Packaging Work Order status for tracking new, disabled, active and completed work order; (9) Packaging Lot/Batch status for tracking active, suspended and completed lots/batches, Commission and Decommission counts available for completed lots/batches, including packaging site management server Notification Management; (10) Verify completed lot/batch counts and manually trigger packaging site management server notifications; (11) Automated workflow moves from one notification rule to the next upon receiving level 4 acknowledgement; (12) Fingerprint system ACK/NACK for Notifications 2.0 for each notification file in a rule set; (13) Quickly identify the one pallet out of many that failed to process; (14) Notification Summary explorer allows users to quickly locate failed (packaging site management server was unable to send) or Not Acknowledged (packaging site management server sent but Level 4 failed to process) notifications, including Administrator Controls; (15) real-time supply chain insight system specific privileges to limit user access to explorers and commands; (16) Scope Policy to limit access to specific sites (aka packaging site management server); (17) Global setting to enable data collection from eligible product serialization and supply chain management software/system 9.0+ packaging site management servers ; (18) 21 CFR Part 11 Audit log for regulatory compliance, including Information On Demand; (19) Enable/disable data collection on individual packaging site management server site servers; (20) remote procedure calls data transfer for faster data transfer with minimal impact to packaging site management server (e.g., minutes instead of hours); (21) 5 groups of product serialization and supply chain management software/system dashboards published in an online data visualization system; and (22) data visualization system user accounts are managed in an online data visualization system. In some examples, dashboards published in an online data visualization system and data visualization system user accounts are managed in an online data visualization system as realized using embedded dashboards. Examples of dashboards are shown above in connection with FIGS. 5-10.

In some examples, the system can begin with the single point of view system/platform agent. The single point of view system/platform agent can send information from connected nodes. The single point of view system/platform 1100 is designed to use the same network communication paths that already exist between packaging site management server 1102, line manager 1104, and machine interface and vision system 1106. The agent is installed on each node in the network to enable communications up and down the platform related to operations. The agent is a passive low priority service that does not interfere with the packaging site management server, line manager, and machine interface and vision system primary software or communications.

In some implementations, the systems and techniques can include one or more agents 1108, 1110, and/or 1112, on the line manager 1104 and Machine Interface and Vision Systems. A centralized agent can be installed on each line manager and machine interface and vision system. The line manager and machine interface and vision system are not designed to have access to the centralized storage cloud, but connection to packaging site management server is desired.

In some implementations, agents 1108, 1110, and/or 1112 installed on the line manager and machine interface and vision system use port 9999 by default to communicate. The port number can be changed during the initial installation of the agent. In some implementations, the agent on Packaging Site Management Server Systems can be installed on each packaging site management server system. The agents on packaging site management server post HTTPS messages to the single point of view system/platform in response to a timed interval (e.g., heartbeat), system alert or escalation (e.g., health), the result of a command (e.g., run diagnostic, send notification), or a message from an underlying agent (e.g., line manager or machine interface and vision system).

In some implementations, the systems and techniques can include Single Point of View System/Platform Server Certificates (SSL). The single point of view system/platform provides a server certificate for deployments. The server-side certificate is used by the agent installed on the packaging site management server to authenticate the web server.

In examples, the single point of view system/platform is configured to get real-time health and status information based on the logical grouping of organizations, sites, environments, cloud resources, and data sources. Users with the designer role can perform the configurations and publish the defined logical groupings called Scenes. Users with the operator role can approve and manage those scenes.

Data sources can be the representations of systems not directly registered with the single point of view system/platform. Data sources are added to topologies to enhance visibility of system interactions. Example: enterprise resource planning (ERP), manufacturing executing system (MES), warehouse management solutions (WMS). Site Servers can be the single point of view system/platform resources that are registered with a particular instance of the single point of view system/platform. For example, the packaging site management server can be a single point of view system/platform resource.

Clouds can represent cloud resources that are registered with a particular instance of the single point of view system/platform. For example, a fingerprint system or anti-counterfeiting and product authentication system can be a registered cloud resource that is represented in a system visualization by a suitable cloud icon. Environments can facilitate a logical separation between test, stage, or production environments. Creating more than one environment allows for testing and refinement before moving into a production environment. Environments can consist of various assets such as clouds, site servers, and data sources. Defined Environments are used to create sites.

Sites can represent a physical location where products are manufactured, or a larger physical location broken up into smaller more manageable components. Example: Princeton, New Jersey, New York-east end, New York-west. Defined Sites are needed to create Organizations. Organizations can represent business units of a larger company. Defined organizations to create scenes. Scenes can allow the real-time health and status information to be displayed by the logical grouping of organizations, sites, environments, cloud resources, and data sources. Scenes can be available after they are configured, published and approved.

The single Point of View System/Platform can include security and other administrator functions. This details logical security features of the single point of view system/platform. In examples, system access can be limited by group/permission/user control. Access to the single point of view system/platform can be controlled by a system of group, permission and user configurations. There are three predefined roles within the single point of view system/platform: Administrator, Designer and Operator. The Administrator role is responsible for managing and maintaining system security. The Designer defines and configures the nodes and assets that can be monitored and managed. The Operator can manage, monitor and process functions such as Production Explorer, Vault, Management and View of Scenes, and Enterprise Notifications.

Groups can have a combination of roles and individual roles have lists of permissions that can be enabled/disabled to allow for strict access control. Individual users are assigned to defined groups. The creation, deletion and modification of groups and users is managed by users with an Administrator role

In examples, system access can be limited by scope. The single point of view system/platform can be further controlled by the creation of a scope policy. A user with an administrator role can define nodes that can be available for view and management on a group basis. For example, if a company has two sites, a group of users can be set up to have access to only one site and a different group only to the other site.

⇔The Audit Explorer allows a user with an Administrator role to view system access and Administrator function changes to the system including logon/logoff, creation/deletion of users and security policy updates. Entries include timestamp, change, change initiator and old/new values where applicable. The user has the ability to filter, sort and export the entries to a csv file.

In examples, a file storage utilization section allows a user with an Administrator role to monitor the single point of view system/platform storage allocation and usage by category and owner. The user has the ability to filter the detailed display of stored documents by multiple parameters such as file format, location, date added and owner. Once displayed the records can be searched and sorted.

A single point of view system/platform enterprise notification feature provides the user access to the notification rules explorer and the notification summary explorer. These two explorers allow users to view and manage packaging site management server notifications without having to login to the packaging site management server.

A notification rules explorer can allow users with the operator role to search for, view and process preconfigured notification rules for a selected lot. Users can create a filter and display notification rules based on multiple parameters such as date added, notification rule state, nodes and products. Users can view all pre-configured notification rules for a selected lot. Only lots that have ended are displayed. Suspended or in-progress lots may not be available.

Once the packaging lot is selected, notification rules associated with that packaging lot can be retrieved and displayed. Lot data, such as the product name, lot start and end time, and manufacturer, are displayed. Additionally, notification rules are displayed in the order that they were configured. Each notification rule is displayed with the rule name and state. A state represents where in the notification lifecycle that rule is. A notification rule can have the following states: 1) Ready to Send; 2) Pending (a notification rule is waiting for the previous notification rule to be completed); 3) In Progress (the packaging site management server is in the process of delivering the messages); 4) Sent (the packaging site management server has successfully completed processing the notification rule); 5) Failed (there was an error during sending messages from packaging site management server); and 6) Completed (user set state to indicate process for current notification rule is finished)

Notifications can be submitted. In examples, users can submit notifications in the order that they were configured. If multiple notification rules have been configured for a processed lot, only the first notification rule is set to the “Ready” state. All other notification rules are set to the “Pending” state. Additionally, users with permission to perform the Send command can select the notification rule that is in the ‘Ready’ state and submit it by selecting the Send command. The submitted notification rule goes into ‘In Progress’state and then the ‘Sent’state, if successful. Otherwise, the ‘Failed’ state can be displayed. Once the first notification rule configured for the lot is processed, if a second notification rule has been configured for that lot, the state of the second notification rule changes to ‘Ready’.

Users can manually update the state of notification rules. Users with permission to perform the Update State command can manually update certain states of notification rules. For example, “In Progress”, “Complete”, and “Failed” can be changed back to “Ready” in order to resubmit. A log entry is created for all notification status changes. The log entry contains: the user making the change, date/time the change occurred, old value/new value.

Users are able to download notification files generated by each notification rule. The notification summary explorer allows users with the operator role to search for and view submitted notification rules. Operator role users are also able to manually update the state of submitted notification rules and download notification files generated by each submitted notification rule. In some implementations an integrated anomaly detection and resolution system provides real-time monitoring of system behavior. The anomaly system, utilizing artificial intelligence and machine learning algorithms, identifies and flags deviations from usual system behavior as anomalies. Upon detection of an anomaly, the system initiates an internal investigation process and takes preliminary corrective measures as deemed appropriate. The anomaly system also generates a detailed report of the anomaly for further action by users with Administrator or Designer roles. This allows the platform to maintain high performance and security by promptly identifying and addressing potential issues.

The single point of view system/platform can include scenes and custom views. Scenes are the logical grouping of organizations, sites, environments, cloud resources, site servers and data sources that display real-time health and status information. Once users with the designer role publish scenes, users with the operator role can approve or reject published scenes.

Users with the operator role can also set an approved scene as default or retract it. An approved scene that is set as default can display on the dashboard. Users with the operator role can create personalized views of a published scene that focuses on the areas in the organization topology that are of most interest. Once a custom view is created and saved, it can be set as default to display on the dashboard. Users with the operator role can refine published scenes and customized views by Node, Escalation, Status, Software Versions, Supported Versions and Current on Updates.

The dashboard (e.g., dashboards 132 in FIG. 1) can display the published scene or customized view set as default. Users with the operator role can see the following information on the dashboard: 1) packaging line utilization per site server with packaging line details; 2) graphical overview of the entire topology; 3) list of all nodes with their Status (online/offline); 4) details on system State (normal, warning, critical) Status (online/offline), System Messages (e.g., alarms), Space and CPU utilization per node; and 5) software versions-actual vs supported and current.

Users can select the diagnostic command to generate a downloadable file of detailed system level utilization and health information for troubleshooting purposes. The single point of view system/platform vault explorer offers centralized management of production artifacts (e.g., PDF, drawings) describing and/or supporting the manufacturing process. This allows users to save and organize archives, project documents, printer templates, PLC programs, device configurations, and other installation files in a single secure location. The vault explorer allows users with operator privileges to perform the following functions:

Users can upload files in any format. When uploading files, users can associate those files with identifying and descriptive information. Each file is also assigned a State (e.g., Draft, Validated, Approved). Users can upload files with the same name and have those files saved as a different version of the same file. Each version of a file has associated fields that can be updated. Users can create a filter and displayed files based on multiple parameters such as date added, file state, associated topics and file owner. Users can add any applicable notes for each file. Users can add any reference links to related files stored outside the vault.

Users can modify fields associated with each file. Additionally, users can view a list of uploaded documents with their associated identifying and descriptive information including: 1) general information that was entered when initially uploading the file; 2) each version and associated fields for a file; 3) any applicable notes entered by the user for the file; and 4) any reference links to related files stored outside the vault. Users can download files and view the content. Individual file versions can also be downloaded. Users can delete uploaded files. Individual file versions can also be deleted.

A Production Explorer allows users with the operator role to monitor production activity by reviewing the status of packaging lots and work orders across all sites. Users can create a filter to show either packaging lots or work orders. Display information can be further filtered by multiple parameters such as node, product, date and state of the Packaging Lots/Work Orders.

When viewing work orders and packaging lots, displayed records can be sorted by name and state. The following states are available for a packaging lot: 1) In Progress—packaging lot is active; 2) Suspended—packaging lot is suspended; and 3) Completed—packaging lot has been ended or closed. The following States are available for a work order: 1) Ready—work order is enabled and available on packaging site management server; 2) In Progress—work order has been used to start a packaging lot and that lot is active; 3) Suspended—packaging lot associated with this work order has been suspended; 4) Complete—packaging lot associated with this work order has been ended or closed and therefore this work order is finished; 5) Disabled—work order is disabled on packaging site management server and is not available to line manager to start a lot; and 6) Canceled—work order has been deleted on packaging site management server. Lot detail information is available for completed packaging lots.

In some implementations, the systems and techniques can include functions performed by the components in FIG. 11. The process starts with Operator Roll sending and the single point of view system/platform receiving an Archive Command. All commands include the command and the node address. Upon receiving the Archive Command, the single point of view system/platform performs “Log Event Audit Log & Request Console.” Responses are logged related to the user and status. If a payload is provided, the file can also be logged. Upon completing “Log Event”, the single point of view system/platform sends a command to Node Agent (packaging site management server). The process of sending messages up and down the stack can be similar; however, the command (down) and the payload (up) may differ.

For the real-time supply chain insight system, nodes, a production explorer, packaging site management server notification management, administrator controls, and information on demand are provided. In examples, nodes (for example, packaging site management server, line manager, machine interface and vision system, industrial-coding-traceability-software) include the following: Real-Time product serialization and supply chain management software/system Lot/Batch production tracking; Health and Heartbeat provides node status details; Software Management provides accurate version information and recommended update/upgrade path as well as access to release notes; Diagnostic command runs the node specific diagnostic utility and returns the result into the single point of view system/platform. A vault archive command creates a configuration archive and uploads the file directly into the single point of view system/platform vault. User defined, corporate and site graphical scenes are used to visualize the deploy ments.

In examples, a production explorer includes the following: packaging site management server packaging work order status for tracking new, disabled, active and completed work order; packaging lot/batch status for tracking active, suspended and completed lots/batches; and commission and decommission counts available for completed lots/batches.

In examples, packaging site management server notification management includes the following: verify completed lot/batch counts and manually trigger packaging site management server notifications; automated workflow moves from one notification rule to the next upon receiving level 4 acknowledgement; fingerprint system ACK/NACK for Notifications 2.0 for each notification file in a rule set. Quickly identify the one pallet out of many that failed to process; notification Summary explorer allows users to quickly locate failed (packaging site management server was unable to send) or Not Acknowledged (packaging site management server sent but Level 4 failed to process) notifications.

In examples, administrator controls include the following: real-time supply chain insight system specific privileges to limit user access to explorers and commands; scope policy to limit access to specific sites (aka packaging site management server); global setting to enable data collection from eligible product serialization and supply chain management software/system 9.0+ packaging site management server; and 21 CFR Part 11 Audit log for regulatory compliance.

In examples, information on demand (IOD) includes the following enable/disable data collection on individual packaging site management server site servers; remote procedure calls data transfer for faster data transfer with minimal impact to packaging site management server (e.g., minutes instead of hours); 5 groups of product serialization and supply chain management software/system dashboards published in a data visualization system online, where data visualization system user accounts are managed by an online data visualization system. In some examples, the dashboards are embedded dashboards. In examples, dashboards that are embedded into the single point of view system/platform web user interface pages. In examples, dashboards that are hosted and accessed externally from a third-party website, such as a data visualization system.

In examples, the dashboards are IOD dashboards. IOD dashboards leverage pre-built reporting on cross product data to gain insight into production. The IOD dashboards can be viewed through the data visualization system analytics platform. The dashboards can be pre-configured and include global production, packaging lot details, serial number allocations, serial number pool status, and packaging line performance profiles. The pre-configured dashboards are published and easily accessible from a browser on any workstation or mobile device.

In some implementations, the visualization can include production dashboards. For example, the system can provide a production report. The report can contain counts of processed lots, and items commissioned/decommissioned by site, line, product and packaging level. Users are able to filter on date processed, site, product and line. Report can be split into five sections: site production summary, product production summary, production line summary, annual production summary, and production details. With regard to the site production summary, the following is displayed: top sites based on count of processed lots; top sites based on count of commissioned items; top sites based on count of decommissioned items. With regard to the product production summary, the following is displayed: top products based on count of processed lots; top products based on count of commissioned items; top products based on count of decommissioned items. With regard to the production line summary, the following is displayed: top lines based on count of processed lots; top lines based on count of commissioned items; top lines based on count of decommissioned items. With regard to the annual production summary, the following is displayed: count of processed lots by month for each specified year; count of commissioned items by month for each specified year; count of decommissioned items by month for each specified year. With regard to the production details, the following is displayed: counts of products by site, line, packaging level and state.

A single point of view system/platform document repository contains information about the software, hardware and reference materials. The repository consists of an information center, support center, and training center. All user roles have access to the repository. Additionally, there is a facility for users to upload applicable files and use a folder structure to manage those files.

The information center contains a technical documentation library including general information, product information, and GAMP information. General information includes: release compatibility matrix: users are able to determine software version compatibility between components such as line manager/machine interface and vision system and packaging site management server; blogs: users have access to supply chain relevant blogs; regulatory: users have access to industry relevant regulatory information; webinars: users have access to supply chain relevant webinars; and white Papers: users have access to industry relevant white papers.

Product information includes: device drivers: users have access to detailed technical guides for configuring IPS printer drivers; hardware: users have access to hardware specifications, certifications and drawings; operations Manuals: users have access to operation manuals for non-technical users; release notes: users have access to details on the latest software updates and patches; setup manuals: users have access to setup manuals for software and device configuration; solution summary: users have access to a library of packaging integration modules (PIMs) with easy to follow workflows; technical guides: users have access to detailed technical guides for configuring IPS blocks and understanding products; and vision: users have access to detailed technical guides for configuring vision tools.

GAMP information includes: requirements traceability matrix (RTM)/user requirements specifications (URS): users have access to User Requirements Specifications and Traceability Matrices; and validation qualification (VQ): users have access to installation and operational qualification documentation.

In examples, the support center contains information related to the maintenance of systems including case history, renewal information, software, and customer support. The case history enables users to browse open and closed customer support cases as well as current and prior year case metrics. The renewal information enables users to track license renewal information. The software enables users to view details on new software releases and patches, users are also able to download the latest versions. Customer Support enables users to send requests to customer care and technical support.

In examples, the training center contains information related to training courses and videos including a training schedule, unrestricted videos, and subscription videos. The training Schedule enables users to see available training schedules and detailed information. The unrestricted videos enable the users to view training videos that are included with their maintenance contract. The subscription videos enable users to view specialized online training once subscribed. The single point of view system/platform can incorporate an artificial intelligence-powered content discovery and recommendation engine. This feature enhances the system/platform's capacity for personalized user experience. Leveraging machine learning and natural language processing algorithms, this engine can analyze a user's activity patterns within the platform, including the types of files they access, the nature of support cases they raise, or the training content they interact with. The engine then uses these patterns to recommend the most relevant and helpful content to each user, including but not limited to technical documents, tutorials, webinars, white papers, or previously closed support cases. The recommendation engine can continually learn and improve its recommendations over time as it accumulates more user activity data, thereby enhancing the accuracy and personalization of content discovery for users.

Some manual solutions, such as having operators fill in worksheets, are inexpensive and quick to implement, but the data is often unreliable and very difficult to consolidate. At the other extreme, a sophisticated solution from an industrial automation provider can take months or years to design and implement, call for heavy investment, and extensive production shutdown. Then, once the solution is set up it needs to run for months to collect enough data. There are other boxed tool kits that provide similar capabilities, but the end user needs to design, configure, test and debug before putting them into production. Such issues can be reduced or eliminated by the systems and techniques described in this specification. The present systems and techniques provide packages with components that can be integrated together to meet specific needs. The real-time supply chain insight system discussed in this specification supports use with other products and therefore does not rely on bespoke integration.

Here are some example features of the single point of view system/platform. For example, the single point of view system/platform includes an organization topology. The organization topology can be a graphical view of organizations, sites, environments, data sources and site servers and packaging line systems. The single point of view system/platform includes a real-time system status. The real time status enables an on-demand status and health information for connected systems (nodes). The real time status enables a determination of whether systems status is available (e.g., out of lot or idle), active (e.g., active lots) or offline. The real time status enables a view of system states (maintenance, warning or critical) and related messages such as number of active packaging alarms or system error conditions. The single point of view system/platform includes user defined views. In user defined views, users create personalized views based on the organization topology and can interact with nodes for real-time status updates or to execute actions. The single point of view system/platform includes online technical documentation. The technical documentation library can be accessed, including technical guides, setup manuals, and operations manuals organized by solution and topics. The single point of view system/platform includes online regulatory updates. The online regulatory updates include established regulations and how they impact solutions. The single point of view system/platform includes GAMP document templates, such as VQ, URS and Traceability Matrix templates for use in deploying solutions. The single point of view system/platform includes customer support case history. In examples, the customer support case history is online. This enables a check of status on open cases and review closed cases for one site or across all sites. The single point of view system/platform includes account renewal information. Renewal information includes renewal dates and information for support maintenance and/or SAAS (software as a service) annual fees. The single point of view system/platform includes training schedules and videos. For example, upcoming training classes and review course descriptions can be found. Unrestricted training videos can be viewed. Users can opt in for full access to all training videos.

Here are some more example features of the single point of view system/platform. For example, the single point of view system/platform includes software downloads. In examples, full and patch installation packages can be downloaded from a secured location. The single point of view system/platform includes secure file storage and sharing. In examples, files are saved in a secure location and only accessible by predetermined individuals. For example, files can be shared with customer support or project teams instead of email. The single point of view system/platform includes on demand diagnostics. For example, a diagnostic is launched on a remote system and the results viewed from a different location. Diagnostic results can be sent to customer support for faster assistance. The single point of view system/platform includes a scope policy. Scope policy is created and assigned to limit user access to specific sites. Users can only see data from allowed sites even when viewing a corporate level scene. The single point of view system/platform includes embedded operating system (OS) security updates (KB) status. A list of applied security updates for line level systems can be viewed. List is based on published KB updates for provided embedded OS systems. The single point of view system/platform includes a vault. The vault enables saving and organizing of archives, project documents, printer templates, PLC programs, device configurations or any type of files in a single secure location. Files can be tagged with change control numbers or user defined labels for faster searching. Reference links can be added to related files stored outside the vault. The single point of view system/platform includes packaging lot and work order status. Production based on lots or work orders are monitored. Filter by status such as ready, in-progress, suspended, complete, disabled or canceled. Notes provide details for production state changes. View production counts (commissioned, decommissioned, . . . ) for completed lots and work orders. The single point of view system/platform includes enterprise notification management. In examples, packaging site management server notifications are manually initiated without having to login to the packaging site management server. A notification summary explorer provides fast searching for failed notifications. Third party acknowledgement of processed notifications can be confirmed. The single point of view system/platform includes IOD. History is used to improve the future by leveraging cross product data to gain insight into production. Dashboards include global production, packaging lot details, serial number allocations, serial number pool status, and packaging line performance profiles. The single point of view system/platform includes a customer data pool. The customer data pool enables direct access to a centralized repository of data outside of the live solution databases. The single point of view system/platform includes a serialized and non-serialized system support. In examples, operational intelligence is not limited to serialization systems.

Here are some more example features of the single point of view system/platform. For example, the single point of view system/platform includes roadmap items. In examples, the single point of view system/platform includes event subscriptions that enable subscriptions to pre-defined system events to receive notifications when an alert is triggered. The single point of view system/platform includes a user defined alert policies. Custom alert triggers are created for use in event subscriptions, “e.g., if line is down for 15 minutes, generate alert.” The single point of view system/platform includes alarm categories and priorities. Line level alarms are grouped into categories and priorities set for each group. User roles are specified that can respond to each group. Alert triggers are generated based on alarm priorities. The single point of view system/platform includes serial number pool monitoring. Serial number pools are monitored across an organization. Available serial numbers are checked for a packaging site management server or fingerprint system. The single point of view system/platform includes devices added to user scenes. Line devices such as cameras, printers, PLCs are added to the primary scene bringing greater details at a glance. The single point of view system/platform includes line device events and status: Line device information is added to the available status information. The single point of view system/platform includes packaging line logbooks. The line manager logbook allows line operators to enter information during packaging lot/batch. Supervisor, maintenance and quality personnel can review and comment in the logbooks from the desk. The single point of view system/platform includes file and data retention policies. A platform that enables manufacturers to make their line and site operations fully serialization-ready, enabling compliance with all existing and future regulations across multiple sites globally can follow configured company retention policies.

Here are some more example features of the single point of view system/platform. For example, the single point of view system/platform includes batch record history consolidation: Serialization and batch history data is consolidated into a centralized data storage location. Manual local system data archiving and purging can be eliminated. The single point of view system/platform includes audit trail consolidation. 21 CFR Part 11 is consolidated into a centralized data storage for an organization. Manual local system data archiving and purging can be eliminated. The single point of view system/platform includes a consolidation utility for packaging site management servers. Historical data is consolidated from older systems. A manual utility used to migrate history data from packaging site management servers running software. The single point of view system/platform includes configuration versioning. Automated version control on configuration archives is provided. Software versions are recorded with configuration archives to provide improved management. The single point of view system/platform includes an automated change detection. Line operators are notified of unauthorized changes prior to batch start. Policies are configured to approve or deny batch start by role. Notifications are generated when unauthorized configurations are in production. The single point of view system/platform includes configuration archive management. Configuration archives are stored in a central repository. Access to archives is controlled to prevent restoring outdated or unapproved configurations. Archives are created on demand directly into the archive repository. The single point of view system/platform includes software update scheduling: A software update to be executed can be scheduled by an authorized user on the local system, without email, downloads or USB sticks. Stakeholders can be notified of pending software updates. The single point of view system/platform includes import/export device configuration settings. Device (e.g., printers, scanners, etc.) settings, firmware, and templates are saved as part of the configuration archives. Extent depends on capabilities supported by the device. The single point of view system/platform incorporates third party data in analysis. In examples, data is incorporated from other sources to obtain an overview. In examples, the overview Identifies patterns that generate delays or bottlenecks within an organization. The single point of view system/platform includes automated configuration backups. A configuration backup is created at predetermined intervals, such as the close of each lot or on scheduled dates/times. This ensures the most recent backups to speed disaster recovery. Unlike configuration archives, backups are stored differently and have their one retention policies. The single point of view system/platform includes site database backups. Site database backups are scheduled for disaster recovery. The single point of view system/platform includes spare parts catalog and inventory. This enables knowledge of what spare parts are available and where they are located. Part numbers are quickly identified for ordering replacement parts. A spare parts catalog can be updated. The single point of view system/platform includes disk imaging. In examples, full disk images are created for faster disaster recovery. Automated imaging is scheduled, or a disk image is generated on demand. The single point of view system/platform includes virus scan reports. In examples, virus scans are executed, and virus scan reports are reviewed and saved. Results are saved alongside configuration archives. The single point of view system/platform includes step-by-step recovery walkthroughs. The step-by-step recovery walkthroughs can include documentation and video assistance on recovering different system types. The single point of view system/platform includes device level backups. Device level backups can include backup settings, firmware and templates from printers, scanners, PLC and other line devices. Device backups can be used to restore a replacement device to the same settings as the original. The single point of view system/platform includes central packaging master data management. Packaging master data is centralized for distribution to sites. Partial master date information is imported from multiple sources to get the full definition. The single point of view system/platform includes central packaging work order management. Packaging work orders can be imported, created, scheduled and released for execution. The state of work orders can be controlled to prevent running an incomplete work order. A stop or hold request for active work orders can be remotely issued. Line operators are notified on the local system. An additional feature of the single point of view system/platform includes enhanced data integrity verification. The system can leverage a combination of checksum and cryptographic hashing algorithms to verify the integrity of serialization and batch history data. This ensures that the data, consolidated into a centralized data storage location, has not been tampered with during storage, transmission, or processing. This contributes significantly to securing the audit trail consolidation and negates the need for manual archiving and purging.

The present systems and techniques include serialization that is capable of easily adjusting to new demands while also protecting line throughput, data integrity, and system security. A serialization architecture and important considerations and criteria for evaluating potential serialization solutions is provided. There are three major objectives when implementing serialization: (1) Ensure the integrity of data as it moves between the Enterprise, Plant, Line and Machine Levels. (2) Maintain the throughput of the packaging line without expensive and time-consuming disruptions. (3) Maintain a secure information technology system.

Bi-directional communication is provided. Adding serialization technology necessitates new packaging processes at individual sites which should be accommodated by the enterprise information; technology (IT) infrastructure. The serialization solution can enable effective communication between the packaging and IT environments. Enabling this bi-directional communication provides a new layer of control systems. The new layer acts as a gateway through which data flows. Data management between the enterprise and packaging line is critical for all serialization initiatives because it protects data integrity at the enterprise level while ensuring packaging line throughout.

Total Cost of Ownership (TCO) includes the costs of software, hardware, systems integrations, revalidation, and line efficiencies-as well as supporting a global serialization rollout. Companies can consider the following technology criteria when formulating serialization strategies and controlling TCO: a productized serialization solution is ready to be quickly Installed when it is bought, thereby increasing efficiency and speed of line set-up; an expandable serialization solution easily grows; configurable software is designed with elements that can be assembled and realigned to quickly accommodate changing demands without requiring code re-writes; a turnkey software solution that effectively handles change control management; communication links between critical levels that manage backward compatibility between software versions; open communications between external systems and devices using proven standard interfaces; reduce deployment times by leveraging prior experiences and established use cases instead of “learn as you go” approach.

Level specific considerations are as follows. At the enterprise level ERP/ MES considerations are: How is number format conversion between the plant and the enterprise managed? How are network interruptions minimized to ensure packaging throughput? Is a third party responsible to provide the tools necessary to maintain data integrity? If so, what other role, if any, do they play? How are off-line and post lot operations supported? Plant level (MES) considerations are: How are new country specifications managed? How are evolving changes to existing legislation managed? Is a third party responsible for code changes? How easy is it to add/change products in the existing serialization solution? Line level (Supervisory Control and Data Acquisition) considerations are: Are packaging lines isolated or insulated from plant and enterprise level changes? How does the serialization solution impact line efficiency? Does the serialization solution manage the line or just the serialization devices? Machine level (PLCs and devices) considerations are: What impact will changes to the devices have on the line management system? How many unique Human-Machine Interface (HMI) displays does the serialization solution have? Does the serialization solution positively track the status of the item throughout the line processes?

Supervisory Control and Data Acquisition (SCADA) is a system of hardware and software components used to monitor and control industrial processes, infrastructure, and facilities. SCADA systems gather real-time data from various sensors and devices, provide control commands to remote equipment, and display the collected data to operators for monitoring and decision-making purposes. HMI refers to the user interface or graphical interface that allows humans to interact with machines, devices, or software systems. HMIs provide a visual representation of the system's status, data, and controls, enabling operators to monitor and control the system effectively. HMIs can include touchscreens, buttons, indicators, and other interactive elements to facilitate user interaction.

A major consideration between plant level and line level is: What teams are responsible for maintaining communication between each level? This can be established using bi-directional communication as described above. Offline and Post lot operations considerations are: How are off-line, post lot, rework, QA and centralized palletizing managed and supported? In examples, packaging site management server operates at the plant level with serialized product tracking. In examples, line manager operates at the line level with serialized product tracking. In examples, machine interface and vision system operates at the machine level. In examples, a packaging execution system integrates all packaging line information systems, including vision inspection, line management, performance metrics and serialization. In some implementations, the present systems and techniques can integrate with Internet of Things (IOT) devices and sensors deployed throughout the supply chain to collect real-time data on various parameters, such as temperature, humidity, vibration, or location. The system can use this granular, real-time data to monitor the conditions of items in the supply chain, enabling proactive identification and resolution of potential issues that could impact product quality or safety.

In some implementations, the systems and techniques can include serialized product tracking. Serialization can be performed on the machine, on the line, off the line, in the plant, or a combination of these. For example, serialization on the machine can include device communications: setup, alarms, counters; fixed and variable text formatting; printer template and data downloads in real time; print verification: lot, expire date; product inspection: skew, placement, presents, contents; component verification and commodity codes; real time product inspections and results posting. Serialization on the line can include procedural management oversight; number management done in packaging line real time; support multiple devices in multiple configurations; inclusion of lot number and expiration date along with global trade item number (GTIN) and serial number; support multiple data carries with verification and match; manage aggregation processes; support for manual and automated packaging use cases. Serialization off the line can include: an aggregation integrity can be ensured for all “out of lot” use cases; manages rework for damaged product, quality assurance (QA) sampling and QA inspection; manages central palletizing, pallet reconfiguration and quality assurance operations; tracks and records serialized products up to the point of notification; manages label printing to replace damaged labels. Serialization in the plant can include a variety of notification trigger methods to support unattended operation; automatic provisioning for unattended operation; automatic number conversion for provisioning and notification; minimizes packaging line validation when updating IT systems; prevents packaging line disruptions due to network losses; provides a single IT interface to all packaging lines; near real time communication with packaging line.

In some implementations, a machine interface and vision system can include a high-speed vision processing and complete suite of vision tools for pharmaceutical packaging with the following: dynamic grayscale processing or normalized correlation; user friendly statistical training process; print verification, label skew, placement, presents, contents, component verification, commodity codes; and tight productized interoperability with line manager. The tight productized interoperability with line manager enables the following: reduced risk integration between different vendors; user access control to vision functions and vision; run mode status display from a single user interface; view multiple vision inspections from a single interface; single point for user access control and security integrated with active directory; and single point setup of all vision inspections from line manager at the start of the lot.

In some implementations, the systems and techniques can provide the following benefits and advantages, including making the correct decision regarding number management, ensuring data flow is productized for packaging, ensuring data into the supply chain is correct, use cases engineered through configuration (not code development), eliminates cost exposure to integrate random vision technology with line management software, expandable and maintainable without need of systems integration. The overall solution can be ready to deploy worldwide, providing consistency between sites, and providing consistent training methodology for packaging and IT personnel.

In some implementations, a machine interface and vision system can provide an extensive set of vision tools including Optical Character Verification (OCV), Optical Character Recognition (OCR), Bar Code Verification (BCV) and Print Quality Verification (PQV), which complement general quality inspection functions such as gauging, object presence, shape, defect, count and color. The machine interface and vision system product can include audit logs to provide assurance for procedural control, quality and regulatory compliance. It also conducts device set up, recipe-driven workflow, reject station management, and control of intelligent online devices (printers, barcode scanners, and check weighers) to ensure integrated quality control.

The machine interface and vision system can include the following features: ease of deployment and use; providing higher accuracy and greater benefit because of its “true” OCV capability; exceptional vision inspection speeds; works with color and monochrome images in any combination; state-of-the-art performance for individual character recognition inspections; one-time font-training library; simplifying training and ensures uniformity across all packaging operations since inspections are executed from a single, and consistent and intuitive user interface. Machine interface and vision system product specifications are as follows: supporting an unlimited combination of inspection types from a single camera frame; inspection rate of 3600 (maximum) parts per minute; up to 4 acquisitions in base system; and supports the most diverse range of cameras on the market and expands to control up to 12 camera ports.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented using one or more modules of computer program instructions encoded on a computer-readable medium for execution by, or to control the operation of, data processing apparatus. The computer-readable medium can be a manufactured product, such as hard drive in a computer system or an optical disc sold through retail channels, or an embedded system. The computer-readable medium can be acquired separately and later encoded with the one or more modules of computer program instructions, such as by delivery of the one or more modules of computer program instructions over a wired or wireless network. The computer-readable medium can be a machine-readable storage device, a machine-readable storage substrate, a memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, a runtime environment, or a combination of one or more of them. In addition, the apparatus can employ various different computing model infrastructures, such as web services, distributed computing and grid computing infrastructures.

A computer program (also known as a program, software, software application, script, or code) can be written in any suitable form of programming language, including compiled or interpreted languages, declarative or procedural languages, and it can be deployed in any suitable form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, special purpose microprocessors. Generally, a processor will receive instructions and data from a read-only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM (Erasable Programmable Read-Only Memory), EEPROM (Electrically Erasable Programmable Read-Only Memory), and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., an LCD (liquid crystal display) display device, an OLED (organic light emitting diode) display device, or another monitor, for displaying information to the user, and a keyboard and a pointing device, e.g., a mouse or a trackball, by which the user can provide input to the computer. Other kinds of devices can be used to provide for interaction with a user as well; for example, feedback provided to the user can be any suitable form of sensory feedback, e.g., visual feedback, auditory feedback, or tactile feedback; and input from the user can be received in any suitable form, including acoustic, speech, or tactile input.

The computing system can include clients and servers. A client and server are generally remote from each other and typically interact through a communication network. The relationship of client and server arises by virtue of computer programs running on the respective computers and having a client-server relationship to each other. Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any suitable form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this specification contains many implementation details, these should not be construed as limitations on the scope of what is being or may be claimed, but rather as descriptions of features specific to particular embodiments of the disclosed subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. Thus, unless explicitly stated otherwise, or unless the knowledge of one of ordinary skills in the art clearly indicates otherwise, any of the features of the embodiments described above can be combined with any of the other features of the embodiments described above.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and/or parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the present systems and techniques have been described. Other embodiments are within the scope of the following claims. For example, the actions recited in the claims can be performed in a different order and still achieve desirable results.

### EXAMPLES

Although the present application is defined in the attached claims, it should be understood that the present invention can also (additionally or alternatively) be defined in accordance with the following examples:

### Example 1

A method comprising:
obtaining data regarding items as the items move through a supply chain, wherein the data comprises event data that identifies specific ones of the items at specific locations in the supply chain at specific times;
analyzing the data to produce information while at least a portion of the items move through the supply chain; and
providing a visualization of the information usable to identify one or more changes to make in at least one portion of the supply chain to improve the at least one portion of the supply chain.

### Example 2

The method of Example 1, further comprising identifying items by electronic fingerprints generated from captured images of marks on the items using computer image processing.

### Example 3

The method of Example 1 or Example 2, wherein the data regarding items includes counts for commissioned and decommissioned items for a snapshot in time and/or associated with a segment in the supply chain, and wherein the counts are obtained from inspection data collected on a production line by sensors installed on the production line.

### Example 4

The method of any one of the previous Examples, wherein the obtaining comprises:
receiving serialization data for the items from computers located at production facilities, packaging facilities, distribution facilities, or a combination thereof; and
receiving item authentication data and end-to-end item trace data from computers throughout the supply chain via a global communication network.

### Example 5

The method of any one of the previous Examples, wherein the analyzing comprises:
analyzing data about the at least a portion of the items that are moving through the supply chain; and
analyzing historical data about another portion of the items that have fully passed through the supply chain, which were discarded before fully passing through the supply chain, or both.

### Example 6

The method of any one of the previous Examples, wherein the analyzing comprises producing the information comprising decommissioning information, serial number pool information, packaging line performance information, and packaging lot information.

### Example 7

The method of any one of the previous Examples, wherein the providing comprises sending distinct dashboards for displaying (i) decommissioning events for sites, products and packaging lines, (ii) serial number pool status and serial number allocations, (iii) packaging line utilization and performance, and (iv) packaging lot/batch details including settings, runtimes, events, counts and decommission reasons.

### Example 8

The method of any one of the previous Examples, further comprising identifying trends and potential threats based on predetermined threshold values related to at least one of decommissioning information, serial number pool information, packaging line performance information, and packaging lot information.

### Example 9

The method of any one of the previous Examples, wherein the providing comprises generating an interactive, graphical view for visualizing data related to a serialization number pool, wherein the serialization number pool represents serialization number inventory and the serialization number inventory is obtained from a government authority or a trading partner, and the visualization includes serialization number pool visualization including counts data based on a site, manufacturer, product and package for allocated serialization numbers, used serialization numbers, available serialization numbers, decommissioned serialization numbers, d serialization format, serialization numbers count threshold and a visual indicator for indicating whether the available serialization numbers are above or below the serialization numbers count threshold, wherein the serialization numbers count threshold is a predetermined value set by a customer.

### Example 10

The method of any of any one of the previous Examples, wherein the providing comprises sending distinct sets of information about a specific item to two or more of a manufacturer, a packager, a distributor, a retailer, and an end consumer.

### Example 11

The method of any one of the previous Examples, wherein the providing comprises generating an interactive, graphical view of an organization's sites, environments, data sources, machines, and site servers and packaging line systems.

### Example 12

The method of any one of the previous Examples, wherein the interactive, graphical view includes representations of cameras, printers, barcode scanners, and sensors installed on a production line of the organization.

Similar operations and processes as described in Examples 1 to 12 can be performed in a system comprising at least one process and a memory communicatively coupled to the at least one processor where the memory stores instructions that when executed cause the at least one processor to perform the operations. Further, a non-transitory computer-readable medium storing instructions which, when executed, cause at least one processor to perform the operations as describes in any one of the Examples 1 to 12 can also be implemented.

What is claimed is:

1. A method comprising:
obtaining data regarding items as the items move through a supply chain, wherein the data comprises event data that identifies specific ones of the items at specific locations in the supply chain at specific times;
analyzing the data to produce information while at least a portion of the items move through the supply chain; and
providing a visualization of the information usable to identify one or more changes to make in at least one portion of the supply chain to improve the at least one portion of the supply chain.

2. The method of claim 1, further comprising identifying items by electronic fingerprints generated from captured images of marks on the items using computer image processing.

3. The method of claim 2, wherein the data regarding items includes counts for commissioned and decommissioned items for a snapshot in time and/or associated with a segment in the supply chain, and wherein the counts are obtained from inspection data collected on a production line by sensors installed on the production line.

4. The method of claim 2, wherein the obtaining comprises:
receiving serialization data for the items from computers located at production facilities, packaging facilities, distribution facilities, or a combination thereof; and
receiving item authentication data and end-to-end item trace data from computers throughout the supply chain via a global communication network.

5. The method of claim 2, wherein the analyzing comprises:
analyzing data about the at least a portion of the items that are moving through the supply chain; and
analyzing historical data about another portion of the items that have fully passed through the supply chain, which were discarded before fully passing through the supply chain, or both.

6. The method of claim 1, wherein the analyzing comprises producing the information comprising decommissioning information, serial number pool information, packaging line performance information, and packaging lot information.

7. The method of claim 6, wherein the providing comprises sending distinct dashboards for displaying (i) decommissioning events for sites, products and packaging lines, (ii) serial number pool status and serial number allocations, (iii) packaging line utilization and performance, and (iv) packaging lot/batch details including settings, runtimes, events, counts and decommission reasons.

8. The method of claim 6, further comprising identifying trends and potential threats based on predetermined threshold values related to at least one of decommissioning information, serial number pool information, packaging line performance information, and packaging lot information.

9. The method of claim 1, wherein the providing comprises generating an interactive, graphical view for visualizing data related to a serialization number pool, wherein the serialization number pool represents serialization number inventory and the serialization number inventory is obtained from a government authority or a trading partner, and the visualization includes serialization number pool visualization including counts data based on a site, manufacturer, product and package for allocated serialization numbers, used serialization numbers, available serialization numbers, decommissioned serialization numbers, d serialization format, serialization numbers count threshold and a visual indicator for indicating whether the available serialization numbers are above or below the serialization numbers count threshold, wherein the serialization numbers count threshold is a predetermined value set by a customer.

10. The method of claim 1, wherein the providing comprises sending distinct sets of information about a specific item to two or more of a manufacturer, a packager, a distributor, a retailer, and an end consumer.

11. The method of claim 1, wherein the providing comprises generating an interactive, graphical view of an organization's sites, environments, data sources, machines, and site servers and packaging line systems.

12. The method of claim 11, wherein the interactive, graphical view includes representations of cameras, printers, barcode scanners, and sensors installed on a production line of the organization.

13. A system comprising:
a data processing apparatus including at least one hardware processor; and
a non-transitory computer-readable medium encoding instructions configured to cause the data processing apparatus to perform operations comprising:
obtaining data regarding items as the items move through a supply chain, wherein the data comprises event data that identifies specific ones of the items at specific locations in the supply chain at specific times;
analyzing the data to produce information while at least a portion of the items move through the supply chain; and
providing a visualization of the information usable to identify one or more changes to make in at least one portion of the supply chain to improve the at least one portion of the supply chain.

14. A non-transitory computer-readable medium encoding instructions operable to cause data processing apparatus to perform operations comprising:
obtaining data regarding items as the items move through a supply chain, wherein the data comprises event data that identifies specific ones of the items at specific locations in the supply chain at specific times;
analyzing the data to produce information while at least a portion of the items move through the supply chain; and
providing a visualization of the information usable to identify one or more changes to make in at least one portion of the supply chain to improve the at least one portion of the supply chain.

15. The system of claim 13, wherein the operations further comprise identifying items by electronic fingerprints generated from captured images of marks on the items using computer image processing.

16. The system of claim 14, wherein the data regarding items includes counts for commissioned and decommissioned items for a snapshot in time and/or associated with a segment in the supply chain, and wherein the counts are obtained from inspection data collected on a production line by sensors installed on the production line.

17. The system of claim 14, wherein the obtaining comprises:
receiving serialization data for the items from computers located at production facilities, packaging facilities, distribution facilities, or a combination thereof; and
receiving item authentication data and end-to-end item trace data from computers throughout the supply chain via a global communication network.

18. The system of claim 14, wherein the analyzing comprises:
analyzing data about the at least a portion of the items that are moving through the supply chain; and
analyzing historical data about another portion of the items that have fully passed through the supply chain, which were discarded before fully passing through the supply chain, or both.

19. The system of claim 13, wherein the analyzing comprises producing the information comprising decommissioning information, serial number pool information, packaging line performance information, and packaging lot information.

20. The system of claim 18, wherein the providing comprises sending distinct dashboards for displaying (i) decommissioning events for sites, products and packaging lines, (ii) serial number pool status and serial number allocations, (iii) packaging line utilization and performance, and (iv) packaging lot/batch details including settings, runtimes, events, counts and decommission reasons.
